(19) United States
(12) Patent Application Publication
(10) Pub. No.: US 2026/0292916 A1
(43) Pub. Date: Sep. 24, 2026

(54) CONTROL PLANE MESSAGE OPTIMIZATION FOR ANTENNA CONTROL

(71) Applicant: QUALCOMM Incorporated, San Diego, CA (US)

(72) Inventors: Meemoh HAQUE, Gurugram (IN); Pritha BHATTACHARYA, Delhi (IN); Sri Harshitha MUNAGA, Bengaluru (IN); Surya Teja PATCHIPULUSU, Rajampet (IN); Kshitij Dileepkumar PAWAR, Thane (IN)

(21) Appl. No.: 19/087,934

(22) Filed: Mar. 24, 2025

(51) Int. Cl. H04W 76/20; H04B 7/06; H04L 1/1607; H04W 8/22

(52) U.S. Cl. CPC H04W 76/20; H04B 7/0617; H04L 1/1614; H04W 8/22

(57) ABSTRACT

Aspects relate to a wireless communication system for wireless communication. The wireless communication system may include a network node that receives a first control plane (C-plane) message associated with a plurality of antennas. The first C-plane message indicates one or more active antennas and one or more inactive antennas of the plurality of antennas. The network node transmits a response to the first C-plane message and receives a second C-plane message based on the transmitted response. The second C-plane message includes one or more first beamforming weights for the one or more active antennas. In the second C-plane message, one or more second beamforming weights for the one or more inactive antennas are absent and the one or more first beamforming weights are included in a same sequence in which the one or more active antennas are indicated in the first C-plane message.

### BACKGROUND

### Field of the Disclosure

The present disclosure relates generally to wireless communication systems, and, more particularly, to control plane message optimization in open radio access networks.

### Description of Related Art

Wireless communication systems are widely deployed to provide a range of communication services such as telephony, data transmission, messaging, multimedia streaming, broadcasting, or the like. The wireless communication systems may enable communication between multiple users by employing various multiple-access technologies, for example, Code Division Multiple Access (CDMA), Time Division Multiple Access (TDMA), Frequency Division Multiple Access (FDMA), Orthogonal Frequency Division Multiple Access (OFDMA), or the like. Examples of wireless multiple-access communication systems may include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems. A wireless multiple-access communication system may include one or more base stations that facilitate wireless communication for communication devices such as User Equipment (UE).

In the context of an Open Radio Access Network (O-RAN) architecture, functions of a base station or a network node may be divided across multiple devices or components. For example, an O-RAN network node may include a Radio Unit (RU) and a Distributed Unit (DU). The RU may handle wireless communications with devices, such as UEs, whereas the DU may support the wireless communications performed by the RU. The division of O-RAN network nodes may enable flexibility and scalability but can also necessitate an exchange of information between the DU and RU to ensure seamless operation. One such interaction may involve the DU transmitting configuration details to the RU to control the performance of one or more transceiving elements, such as antennas, associated with the RU. As communication demands increase, there are opportunities to optimize communication interactions between the DU and the RU.

### SUMMARY

Aspects of the disclosure provide a first network node for wireless communication. The first network node includes one or more memories and one or more processors coupled to the one or more memories. The one or more processors are individually or collectively configured to cause the first network node to receive, from a second network node, a first control plane (C-plane) message associated with a plurality of antennas, where the first C-plane message indicates one or more active antennas of the plurality of antennas and one or more inactive antennas of the plurality of antennas. Further, the one or more processors are individually or collectively further configured to cause the first network node to transmit, to the second network node, a response to the first C-plane message. Furthermore, the one or more processors are individually or collectively further configured to cause the first network node to receive, from the second network node, a second C-plane message based on the transmitted response, where the second C-plane message includes one or more first beamforming weights for the one or more active antennas, respectively. In the second C-plane message, one or more second beamforming weights for the one or more inactive antennas are absent and the one or more first beamforming weights are included in a same sequence in which the one or more active antennas are indicated in the first C-plane message.

In some aspects of the disclosure, a first network node for wireless communication is provided. The first network node includes one or more memories and one or more processors coupled to the one or more memories. The one or more processors are individually or collectively configured to cause the first network node to transmit, to a second network node, a first C-plane message associated with a plurality of antennas, where the first C-plane message indicates one or more active antennas of the plurality of antennas and one or more inactive antennas of the plurality of antennas. Further, the one or more processors are individually or collectively further configured to cause the first network node to generate a second C-plane message that includes one or more first beamforming weights for the one or more active antennas, respectively. In the second C-plane message, one or more second beamforming weights for the one or more inactive antennas are absent and the one or more first beamforming weights are included in a same sequence in which the one or more active antennas are indicated in the first C-plane message. Furthermore, the one or more processors are individually or collectively further configured to cause the first network node to transmit the second C-plane message to the second network node.

In some more aspects of the disclosure, a wireless communication method in a first network node is provided. The wireless communication method includes receiving, from a second network node, a first control plane (C-plane) message associated with a plurality of antennas, where the first C-plane message indicates one or more active antennas of the plurality of antennas and one or more inactive antennas of the plurality of antennas. Further, the wireless communication method includes transmitting, to the second network node, a response to the first C-plane message. Furthermore, the wireless communication method includes receiving, from the second network node, a second C-plane message based on the transmitted response, where the second C-plane message includes one or more first beamforming weights for the one or more active antennas, respectively. In the second C-plane message, one or more second beamforming weights for the one or more inactive antennas are absent and the one or more first beamforming weights are included in a same sequence in which the one or more active antennas are indicated in the first C-plane message.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of an Open Radio Access Network (O-RAN) architecture, in accordance with certain aspects of the present disclosure;

FIG. 2 is a diagram that illustrates an example of a message flow between a Distributed Unit (DU) and a Radio Unit (RU), in accordance with certain aspects of the present disclosure;

FIG. 3 is a diagram that illustrates an example of a first control plane (C-plane) message, in accordance with certain aspects of the present disclosure;

FIG. 4 is a diagram that illustrates an example of a second C-plane message, in accordance with certain aspects of the present disclosure;

FIG. 5 is a diagram that illustrates a flowchart of a process (e.g., a method) for receiving one or more C-plane messages, in accordance with certain aspects of the present disclosure;

FIG. 6 is a diagram that illustrates a flowchart of a process (e.g., a method) for executing wireless communication, in accordance with certain aspects of the present disclosure;

FIG. 7 is a diagram that illustrates a flowchart of a process (e.g., a method) for converting first beamforming weight information to second beamforming weight information, in accordance with certain aspects of the present disclosure;

FIG. 8 is a diagram that illustrates a high-level flowchart of a process (e.g., a method) for transmitting one or more C-plane messages, in accordance with certain aspects of the present disclosure;

FIG. 9 is a diagram that illustrates a detailed flowchart of a process (e.g., a method) for transmitting one or more C-plane messages, in accordance with certain aspects of the present disclosure; and

FIG. 10 is a diagram that illustrates an example of a Radio Access Network (RAN) node, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

An Open Radio Access Network (O-RAN) architecture may enable the functions of a base station to be distributed across multiple devices or components. For example, a network node within the O-RAN architecture may correspond to a Radio Unit (RU) and/or a Distributed Unit (DU). The RU may handle wireless communications with communication devices, such as User Equipment (UE), while the DU may support the wireless communications performed by the RU. While the division of base station functionalities allows for flexibility and scalability, the division of base station functionalities may also involve an exchange of information between the DU and RU to ensure seamless operation.

One such interaction between the DU and RU may involve the DU transmitting a control plane (C-plane) message to the RU to control the performance of antennas associated with the RU. For example, the DU may instruct the RU to disable certain antennas to conserve energy when these antennas are not in use for active communication. Additionally, the DU may transmit additional C-plane message to optimize the overall performance of the antennas, improve the efficiency of the antennas, and/or adapt the antennas to varying communication requirements. For example, the DU may communicate configuration details (e.g., beamforming weights) for the antennas to enhance signal focus and coverage.

In conventional implementations, the DU may transmit the beamforming weights without accounting for the operational status of the antennas. For example, the beamforming weights may be transmitted indiscriminately for all antennas, regardless of whether the antennas are enabled or disabled. Accordingly, redundant information related to disabled antennas may be transmitted over a fronthaul interface between the DU and RU. The transmission of redundant information may consume additional bandwidth and increase communication overhead in the fronthaul interface. Further, the transmission of redundant information may increase processing requirements on both the DU and RU, which in turn can lead to higher latency, reduced resource availability, and impact overall network performance.

Certain aspects disclosed herein provide systems and methods for C-plane message optimization for antenna control. In an example, the DU may transmit, to the RU, a first C-plane message associated with a plurality of antennas. The first C-plane message may indicate one or more active antennas of the plurality of antennas and one or more inactive antennas of the plurality of antennas. In an example, an active antenna of the active antennas may correspond to (or include) a first antenna of the plurality of antennas that is to be activated (or that shall remain active, turned ON). For example, an inactive antenna of the inactive antennas may correspond to a second antenna of the plurality of antennas that is to be deactivated (or that shall remain inactive, turned OFF). The second antenna may be different from the first antenna within the plurality of antennas. Further, the RU may transmit, to the DU, a response to the first C-plane message. In an example, the response may include an acknowledgment (ACK) indicating that the reception of the first C-plane message was successful.

In some aspects, upon receiving the response, the DU may generate a second C-plane message and transmit the second C-plane message to the RU. In some examples, the second C-plane message may include first beamforming weight information in a reduced format. The first beamforming weight information in the reduced format may exclusively indicate one or more first beamforming weights (also referred to as the “first beamforming weights”) for the active antennas. In other words, the first beamforming weight information in the reduced format may not indicate (or not include) one or more second beamforming weights (also referred to as the “second beamforming weights”) for the inactive antennas. Accordingly, the second C-plane message may be optimized to exclusively include the first beamforming weights for the active antennas. Thus, the second beamforming weights for the inactive antennas may be absent in the second C-plane message. Further, in the second C-plane message, the first beamforming weights may be included in a same sequence in which the active antennas are indicated in the first C-plane message.

Since the second beamforming weights are absent in the second C-plane message, the second beamforming weights may not be relayed to the RU via the fronthaul. Thus, the overhead in the fronthaul interface may be reduced, which in turn can enable to improve network performance, such as network latency, network bandwidth, or the like. Since the first beamforming weights in the second C-plane message are included in the same sequence in which the active antennas are indicated in the first C-plane message, the RU may be enabled to not perform additional processes, such as performing a mapping between the first beamforming weights and the active antennas, determining which weight among the first beamforming weights corresponds to an antenna of the plurality of antennas, or the like. Accordingly, the demand for the computation resources of the RU may be reduced.

In further aspects, the RU may control the plurality of antennas. In some examples, to control the plurality of antennas, the RU may obtain the second beamforming weights for the inactive antennas and convert the first beamforming weight information in the reduced format to second beamforming weight information in an expanded format. In some examples, the first beamforming weight information may be converted to the second beamforming weight information based on the obtained second beamforming weights. In further examples, the conversion of the first beamforming weight information to the second beamforming weight information may include adding the obtained second beamforming weights to the first beamforming weights in the second C-plane message received by the RU from the DU. In furthermore examples, the conversion of the first beamforming weight information to the second beamforming weight information may include padding the first beamforming weights with one or more zeroes, where the zeroes can correspond to the second beamforming weights. Furthermore, the plurality of antennas may be controlled based on the first C-plane message and/or the second beamforming weight information.

In some examples, the control of the plurality of antennas may include activating or deactivating each antenna of the plurality of antennas based on the first C-plane message. In some more examples, the control of the plurality of antennas may include configuring (or assigning) the plurality of antennas with corresponding first beamforming weights and second beamforming weights included in the second beamforming weight information. In this way, the plurality of antennas may be controlled by communicating the first C-plane message and/or the second C-plane message from the DU to the RU.

In further aspects, the RU may transmit a capability indicator to the DU. In some examples, the capability indicator may be transmitted at the time of bootup of the RU (and/or the DU). In some more examples, the capability indicator may specify whether the RU supports the first beamforming weight information in the reduced format or not. Accordingly, by transmitting the capability indicator from the RU to the DU, the DU can be made aware of whether the RU supports the first beamforming weight information in the reduced format. Consequently, if the O-RAN architecture includes one or more RUs that do not support the first beamforming weight information in the reduced format, the DU may refrain from transmitting, to these RUs, the second C-plane message that includes the first beamforming weight information in the reduced format. Additionally or alternatively, the DU may transmit a third C-plane message that includes beamforming weights for both the active antennas and the inactive antennas. Therefore, the capability indicator may enable the DU to communicate beamforming weights without compromising on the network reliability.

In furthermore aspects, the DU may transmit a format indicator to the RU. In some examples, the format indicator may be transmitted via the first C-plane message. In some more examples, the format indicator may specify whether the second C-plane message, which follows the first C-plane message, comprises the first beamforming weight information in the reduced format. Accordingly, by transmitting the format indicator from the DU to the RU, the RU can be made aware of whether the second C-plane message, which follows the first C-plane message, comprises the first beamforming weight information in the reduced format. In other words, transmission of the format indicator having a configured value from the DU may indicate to the RU that in the second C-plane message, which follows the first C-plane message, the second beamforming weights for the inactive antennas will be absent.

The terms “Radio Unit” (RU) and “Distribution Unit” (DU) are used herein for illustrative and descriptive purposes to reference functional components within a wireless communication network. These terms are not intended to limit the scope of the disclosure to any specific terminology or technology. It will be apparent to a person skilled in the art that as technology evolves, these network nodes may be referred to by different names or have different functional groupings. Therefore, the terms RU and DU can encompass equivalent structures, devices, or functional units regardless of the terminology used in future technologies or implementations.

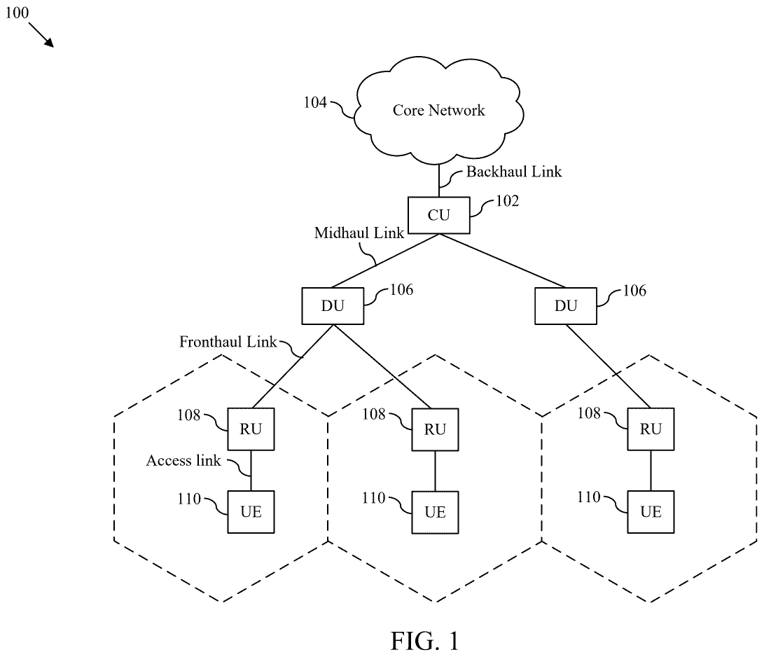

FIG. 1 is a diagram that illustrates an example of an Open Radio Access Network (O-RAN) architecture 100, in accordance with certain aspects of the present disclosure. In various aspects, the O-RAN architecture 100 may be implemented by one or more network nodes of a wireless communication system. In an example, the wireless communication system may include a fourth-generation (4G) system, a fifth-generation (5G) system, future generations, or the like. For example, a network node of the network nodes may include a New Radio (NR) base station, a Long-Term Evolution (LTE) base station, a Node B, an Evolved Node B (eNB), a Next Generation Node B (gNB), a Radio Access Network (RAN) node, an access point, a transmission-reception point (TRP), a mobile entity of a wireless communication network, or the like.

As shown in FIG. 1, the O-RAN architecture 100 may include a Central Unit (CU) 102 that is communicatively coupled to a core network 104 via a backhaul link. In an example, the CU 102 may be implemented within the network node of the one or more network nodes. Further, the O-RAN architecture 100 may include one or more Distributed Units (DUs) 106 and one or more Radio Units (RUs) 108. The DUs 106 may be communicatively coupled to the CU 102 via a respective midhaul link. Further, the DUs 106 may be communicatively coupled to at least one corresponding RU of the RUs 108 via at least one respective fronthaul link. The DUs 106 may be co-located with the CU 102, or alternatively, may be distributed across one or more different network nodes of the network nodes. The RUs 108 may be co-located with a corresponding DU of the DUs 106, or alternatively, may be distributed across a different network node of the network nodes. Further, the RUs 108 may be communicatively coupled to at least one corresponding User Equipment (UE) 110 via a respective radio frequency (RF) access link. Examples of the UE 110 may include a cellular phone, a personal digital assistant (PDA) device, a wireless modem, a wireless communication device, a handheld device, a laptop computer, a wireless local loop (WLL) station, a tablet, a camera, a gaming device, a wearable device, or the like.

In various aspects, the CU 102 may host one or more higher-layer control functions for network control and/or signaling. In an example, the higher-layer control functions may include Radio Resource Control (RRC) functions, Packet Data Convergence Protocol (PDCP) functions, Service Data Adaptation Protocol (SDAP) functions, or the like. Each higher-layer control function of the higher-layer control functions may be implemented with an interface that is configured to communicate signals with higher-layer control functions hosted by the CU 102. Further, the CU 102 may be configured to handle a user plane functionality (for example, a Central Unit-User Plane (CU-UP) functionality), a control plane functionality (for example, a Central Unit-Control Plane (CU-CP) functionality), or a combination thereof. In some aspects, the CU 102 may be logically split into one or more CU-UP units and one or more CU-CP units to handle the user plane functionality and the control plane functionality, respectively. In some more aspects, the CU 102 may be implemented to communicate with the DUs 106 for the network control and/or signaling.

Each of the DUs 106 may correspond to a logical unit that includes one or more base station functions to control the operation of the corresponding RU of the RUs 108. In further aspects, each of the DUs 106 may host one or more of a Radio Link Control (RLC) layer, a Medium Access Control (MAC) layer, and one or more high-physical (high-PHY) layers depending, at least in part, on a functional split, such as a functional split defined by the 3rd Generation Partnership Project (3GPP). Further, each layer hosted by a DU 106 of the DUs 106 may be implemented with an interface that is configured to communicate signals with remaining layers hosted by the DU 106, or with the higher-layer control functions hosted by the CU 102. In some implementations, the DUs 106 may host the high-PHY layers for forward error correction (FEC) encoding and decoding, scrambling, or modulation and demodulation, for example.

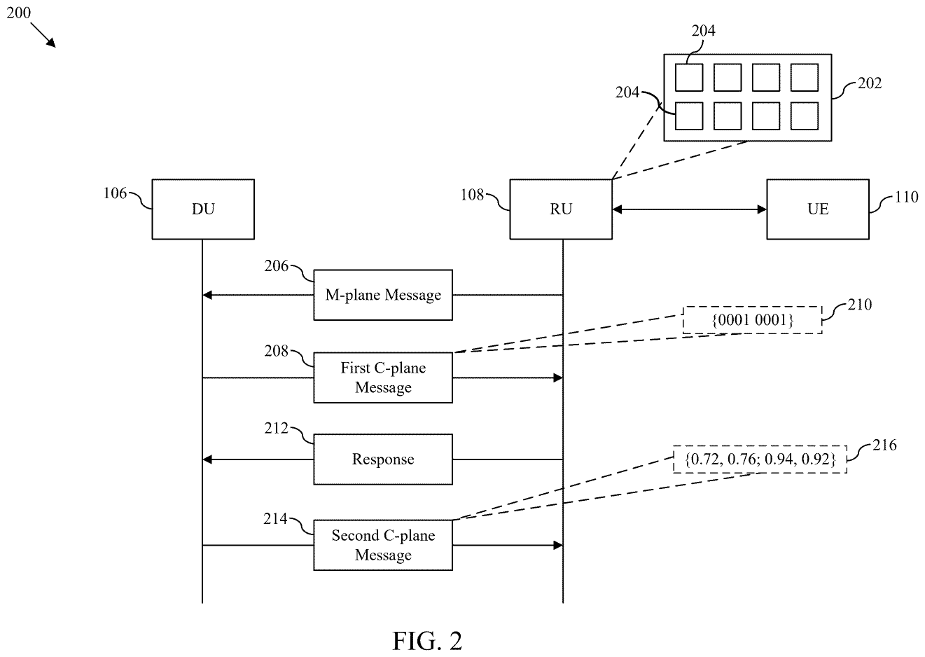

Each of the RUs 108 may implement one or more lower-layer functionalities depending, at least in part, on the functional split defined by the 3GPP. The lower-layer functionalities may correspond to one or more low-physical (low-PHY) layer functions supported by a low-PHY layer or one or more RF processing functions. For example, the lower-layer functionalities may include performing a Fast Fourier Transform (FFT), performing an inverse Fast Fourier Transform (iFFT), digital beamforming, or Physical Random-Access Channel (PRACH) extraction and filtering, for example. In some aspects, each RU of the RUs 108 may be controlled by the corresponding DU of the DUs 106 to handle over-the-air (OTA) communication with the UE 110. In some implementations, to handle the OTA communication, the DUs 106 may control one or more real-time, near real-time, or non-real-time aspects of control plane (C-plane) communication (and/or user plane “U-plane” communication) with the RUs 108. For example, the real-time, near real-time, or non-real-time aspects of the C-plane communication, which are controlled by the DUs 106, are explained in the conjunction with FIG. 2-9.

FIG. 2 is a diagram that illustrates an example of a message flow 200 between the DU 106 and the RU 108, in accordance with certain aspects of the present disclosure. FIG. 2 is explained in conjunction with FIG. 1. As shown in FIG. 2, the RU 108 may be communicatively coupled to at least one antenna array 202. The antenna array 202 may include a plurality of antennas 204. Each antenna of the plurality of antennas 204 may be configured to transmit (and/or receive) at least one wireless signal. For example, the plurality of antennas 204 may include patch antennas, dipole antennas, or the like, which can be arranged in a linear pattern, a two-dimensional pattern, or a different pattern. In a non-limiting example shown in FIG. 2, the plurality of antennas 204 may include eight antennas, with four antennas being arranged in a first row and a second row of the antenna array 202. The antenna array 202 may be integrated within the network node that hosts the RU 108, or alternatively, may be located outside the network node that hosts the RU 108.

In some aspects, the RU 108 may utilize the plurality of antennas 204 to perform wireless communication with the UE 110. In an example, the wireless communication may be performed by forming one or more beams using the plurality of antennas 204. In some examples, the beamforming may involve generating a beam by phase-shifting wireless signals associated with different antennas of the plurality of antennas 204. The generated beam may carry data, such as physical information or reference signal information, intended for communication with a receiving device, such as the UE 110. In an example, the generated beam may correspond to a directional signal that is transmitted in a direction of the receiving device.

In the aspects shown in FIG. 2, the message flow 200 may include transmitting a management plane (M-plane) message 206. In various aspects, the RU 108 may be configured to transmit the M-plane message 206 to the DU 106. The M-plane message 206 may include antenna configuration information, one or more signal quality indicators associated with the UE 110, or the like. In an example, the antenna configuration information may include a count of the plurality of antennas 204, an antenna identifier associated with each antenna of the plurality of antennas 204, one or more antenna modes (for example, beamforming capabilities, Multiple-Input Multiple-Output (MIMO) configurations) associated with the plurality of antennas 204, health or fault statuses of the plurality of antennas 204, or the like. For example, the signal quality indicators may include a Signal-to-Noise Ratio (SNR) associated with the UE 110, a Reference Signal Received Power (RSRP) associated with the UE 110, a Reference Signal Received Quality (RSRQ) associated with the UE 110, or the like.

Upon receiving the M-plane message 206, the DU 106 may be configured to determine, among the plurality of antennas 204, one or more first antennas that are to be activated (or that shall remain active, turned ON) for performing the wireless communication with the UE 110. In an example, the one or more first antennas may be determined based on the M-plane message 206, one or more Quality of Service (QoS) policies supported by the DU 106 (and/or the CU 102), or the like. For example, the QoS policies may include a network coverage policy, a UE handover policy, an energy-saving policy, or the like.

Additionally, or alternatively, the DU 106 may be configured to determine, among the plurality of antennas 204, one or more second antennas that are to be deactivated (or that shall remain inactive, turned OFF) while performing the wireless communication. In other words, the DU 106 may be configured to determine, among the plurality of antennas 204, the one or more second antennas that do not contribute to the wireless communication. In an example, the one or more second antennas may be determined based on the M-plane message 206, the Quality of Service (QoS) policies, or the like. In some examples, the one or more second antennas may include the remaining antennas of the plurality of antennas 204 that are excluded from the one or more first antennas. Hereinafter, the one or more first antennas may be referred to as the “one or more active antennas” or the “active antennas” and the one or more second antennas may be referred to as the “one or more inactive antennas” or the “inactive antennas” based on corresponding operational status (e.g., active or inactive).

For the aspects shown in FIG. 2, the DU 106 may determine, among the plurality of antennas 204, first through third antennas and fifth through seventh antennas as the inactive antennas. In other words, the DU 106 may determine the first three leftmost antennas in both the first row and the second row of the antenna array 202, as the inactive antennas. Further, the DU 106 may determine, among the plurality of antennas 204, fourth antenna and eighth antenna as the active antennas. In other words, the DU 106 may determine the rightmost antennas in both the first row and the second row of the antenna array 202, as the active antennas.

Upon determining the active antennas and the inactive antennas of the plurality of antennas 204, the DU 106 may be configured to generate a first C-plane message 208 associated with the plurality of antennas 204. In an example, the first C-plane message 208 may correspond to a Section Type 4 (ST4) message (for example, a ST4 (cmdtype3) message) utilized for configuring or managing the wireless communication. In various examples, the first C-plane message 208 may indicate the active antennas and the inactive antennas of the plurality of antennas 204.

In some aspects, to generate the first C-plane message 208, the DU 106 may be configured to generate a bitmap 210 for the plurality of antennas 204. In some examples, the bitmap 210 may include a plurality of bits for the plurality of antennas 204, respectively. The plurality of bits may include a first set of bits, each with a first value (for example, a Boolean value of ‘1’), indicating the active antennas of the plurality of antennas 204. The plurality of bits may further include a second set of bits, each with a second value (for example, a Boolean value of ‘0’), indicating the inactive antennas of the plurality of antennas 204. In some more examples, the plurality of bits in the bitmap 210 may be in a specific sequence, and each bit in the bitmap 210 may correspond to a specific antenna among the plurality of antennas 204. The sequence of the plurality of bits in the bitmap 210 may depend on positions of the plurality of antennas 204 in the antenna array 202. For example, the Most Significant Bit (MSB) in the bitmap 210 may correspond to the leftmost antenna in the first row of the antenna array 202 and the Least Significant Bit (LSB) in the bitmap 210 may correspond to the rightmost antenna in a last row (e.g., the second row) of the antenna array 202. Mapping between the plurality of antennas 204 and the plurality of bits in the bitmap 210 may follow an order defined by the positions of the plurality of antennas 204 in the antenna array 202.

In a non-limiting example shown in FIG. 2, the bitmap 210 may be denoted as “{0001 0001}” with ‘0’s and ‘1’s indicating the inactive antennas (e.g., the first through third antennas and the fifth through seventh antennas that are to be deactivated) and the active antennas (e.g., the fourth antenna and the eighth antenna that are to be activated), respectively. Upon generating the bitmap 210, the DU 106 may configure the first C-plane message 208 to include the bitmap 210. Accordingly, the first C-plane message 208 may indicate the active antennas and the inactive antennas of the plurality of antennas 204.

Upon generating the first C-plane message 208, the DU 106 may be configured to transmit the first C-plane message 208 to the RU 108. In an example, the first C-plane message 208 may be transmitted to the RU 108 via a fronthaul interface (e.g., the fronthaul link) between the DU 106 and the RU 108. Upon receiving the first C-plane message 208, the RU 108 may be configured to determine whether the first C-plane message 208 is received completely. In some examples, to determine whether the first C-plane message 208 is received completely, the RU 108 may be configured to perform one or more verification/validation processes on the first C-plane message 208. In an example, the verification/validation processes may include a checksum validation process, a length verification process, or the like.

In some aspects, if the first C-plane message 208 is completely received, the RU 108 may be configured to transmit, to the DU 106, a response 212 for the first C-plane message 208. In an example, the response 212 may include an acknowledgment (ACK) indicating that the reception of the first C-plane message 208 was successful. However, in some examples, if the first C-plane message 208 is not completely received, the RU 108 may prohibit the transmission of the response 212. In some more examples, if the first C-plane message 208 is not completely received, the RU 108 may transmit, to the DU 106, a response including a negative acknowledgment (NACK). The NACK may indicate that the reception of the first C-plane message 208 was unsuccessful. Upon receiving the response including the NACK (or upon receiving no response for a specific time duration), the DU 106 may be configured to re-transmit the first C-plane message 208 to the RU 108.

In some more aspects, if the received response 212 includes the ACK, the DU 106 may be configured to determine a plurality of beamforming weights for the plurality of antennas 204, respectively. In various examples, each beamforming weight of the plurality of beamforming weights may represent a set of complex coefficient values, defined by I (in-phase) and Q (quadrature) components, utilized to control the amplitude and/or phase of the wireless signal associated with the respective antenna of the plurality of antennas 204. The plurality of beamforming weights may include one or more first beamforming weights, which correspond to the one or more active antennas of the plurality of antennas 204, and one or more second beamforming weights, which correspond to the one or more inactive antennas of the plurality of antennas 204. Hereinafter, the one or more first beamforming weights may be collectively referred to as the “first beamforming weights” and the one or more second beamforming weights may be collectively referred to as the “second beamforming weights”.

In some examples, the plurality of beamforming weights may be determined by executing one or more beamforming algorithms, such as a Minimum Mean Square Error (MMSE) algorithm, a Maximum SNR (Max-SNR) algorithm, or the like. In an example, the DU 106 may execute the beamforming algorithms based on one or more of the antenna configuration information, the signal quality indicators, or the QoS policies. In some more examples, during the determination of the plurality of beamforming weights, the DU 106 may be configured to determine the first beamforming weights for the active antennas while prohibiting the determination of the second beamforming weights for the inactive antennas. In these examples, by prohibiting the determination of the second beamforming weights, the demand for the computation resources of the DU 106 can be reduced. In an example, the first beamforming weights may include a beamforming weight (e.g., a set of complex coefficient values, “0.72, 0.76”) for the fourth antenna of the plurality of antennas 204 and a beamforming weight (e.g., a set of complex coefficient values, “0.94, 0.92”) for the eighth antenna of the plurality of antennas 204.

In further aspects, upon determining the plurality of beamforming weights (or upon determining the first beamforming weights), the DU 106 may be configured to generate a second C-plane message 214. In an example, the second C-plane message 214 may correspond to a Section Type 1 (ST1) message that is used to convey configurational details for beamforming. In various examples, the second C-plane message 214 may exclusively include the first beamforming weights for the active antennas, respectively.

In some aspects, to generate the second C-plane message 214, the DU 106 may be configured to generate first beamforming weight information 216 based on the determined plurality of beamforming weights (or the determined first beamforming weights). In various examples, the first beamforming weight information 216 may be generated such that the first beamforming weight information 216 exclusively indicates the first beamforming weights corresponding to the active antennas. In other words, the first beamforming weight information 216 may be generated such that the first beamforming weight information 216 does not indicate (or include) the second beamforming weights corresponding to the inactive antennas. Consequently, the generated first beamforming weight information 216 may be in a reduced format. As used herein, the reduced format may correspond to a version of beamforming weight information that is reduced from indicating the plurality of beamforming weights to exclusively indicating the first beamforming weights. In other words, the reduced format may correspond to a reduced version of the beamforming weight information, which does not indicate (or include) the second beamforming weights, or in which the second beamforming weights are absent.

In some examples, the first beamforming weight information 216 may be generated such that the first beamforming weights in the first beamforming weight information 216 are indicated in the same sequence in which the active antennas are indicated in the first C-plane message 208. In other words, in the first beamforming weight information 216, occurrences of the first beamforming weights may follow the same sequence in which the active antennas are indicated in the first C-plane message 208. For example, if the fourth antenna is indicated prior to the eighth antenna in the first C-plane message 208, an occurrence of the beamforming weight of the fourth antenna may also be prior to an occurrence of the beamforming weight of the eighth antenna in the second C-plane message 214. In the aspects shown in FIG. 2, the first beamforming weight information 216 may be denoted as “{0.72, 0.76; 0.94, 0.92}” with ‘0.72, 0.76’ being the beamforming weight of the fourth antenna and ‘0.94, 0.92’ being the beamforming weight of the eighth antenna.

Upon generating the first beamforming weight information 216, the DU 106 may configure the second C-plane message 214 to include the first beamforming weight information 216. Accordingly, the second C-plane message 214 may exclusively include the first beamforming weights for the active antennas. In other words, the second beamforming weights for the inactive antennas may be absent in the second C-plane message 214. Further, in the second C-plane message 214, the first beamforming weights may be included in the same sequence in which the active antennas are indicated in the first C-plane message 208. Upon generating the second C-plane message 214, the DU 106 may be configured to transmit the second C-plane message 214 to the RU 108. In an example, the second C-plane message 214 may be transmitted to the RU 108 via the fronthaul interface.

Since the second beamforming weights for the inactive antennas are absent in the second C-plane message 214, the second beamforming weights of the inactive antennas may not be communicated to the RU 108 over the fronthaul interface. As a result, the overhead in the fronthaul interface may be reduced which in turn enables to improve network performances, such as network latency, network bandwidth, or the like. Furthermore, since the first beamforming weights in the second C-plane message 214 are included in the same sequence in which the active antennas are indicated in the first C-plane message 208, the RU 108 can operate without performing additional processes, such as performing a mapping between the first beamforming weights and the active antennas, determining which weight among the first beamforming weights corresponds to an antenna of the plurality of antennas, or the like. Accordingly, the demand for the computation resources of the RU 108 may be reduced.

Upon receiving the second C-plane message 214, the RU 108 may be configured to determine whether beamforming weight information, in the second C-plane message 214, corresponds to the first beamforming weight information 216 in the reduced format. In an example, the RU 108 may determine that the beamforming weight information of the second C-plane message 214 corresponds to the first beamforming weight information 216 in the reduced format by comparing a count of beamforming weights of the beamforming weight information with a count of bits of the bitmap 210.

Upon determining that the beamforming weight information of the second C-plane message 214 corresponds to the first beamforming weight information 216 in the reduced format, the RU 108 may be configured to obtain the second beamforming weights for the inactive antenna. In an example, each beamforming weight of the obtained second beamforming weights may represent a set of configured complex coefficient values (e.g., “0, 0”). Upon obtaining the second beamforming weights, the RU 108 may be configured to convert the first beamforming weight information 216 to second beamforming weight information. In various examples, the second beamforming weight information may include the first beamforming weights of the active antennas and the obtained second beamforming weights of the inactive antennas. In other words, the second beamforming weight information may include the plurality of beamforming weights for the plurality of antennas, respectively. Consequently, the second beamforming weight information may be in an expanded format. As used herein, the expanded format may correspond to a version of beamforming weight information that is expanded from exclusively indicating the first beamforming weights to indicating the plurality of beamforming weights. In other words, the expanded format may correspond to an expanded version of the beamforming weight information, which indicates both the first beamforming weights of the active antennas and the second beamforming weights of the inactive antennas.

In some aspects, to convert the first beamforming weight information 216 to the second beamforming weight information, the RU 108 may be configured to add the obtained second beamforming weights to the first beamforming weight information 216. In various examples, the obtained second beamforming weights may be added to the first beamforming weight information 216 based on the specific sequence in which the inactive antennas are indicated in the first C-plane message 208. In an example, a beamforming weight of the obtained second beamforming weights may be added to the first beamforming weight information 216 such that an index position of the beamforming weight in the second beamforming weight information corresponds to an index position at which a corresponding inactive antenna of the inactive antennas is indicated in the first C-plane message 208. Consequently, in the second beamforming weight information, each beamforming weight of the second beamforming weights may be at the same indexed position at which the corresponding inactive antenna of the inactive antennas is indicated in the first C-plane message 208. Further, since the first beamforming weights in the first beamforming weight information 216 are indicated in the same sequence in which the active antennas are indicated in the first C-plane message 208, each beamforming weight of the first beamforming weights in the second beamforming weight information may also be at the same indexed position at which a corresponding active antenna of the active antennas is indicated in the first C-plane message 208.

In some more examples, the addition of the obtained second beamforming weights to the first beamforming weight information 216 may include padding the first beamforming weights with zeroes, where the zeroes can correspond to the second beamforming weights. In an example, the first beamforming weights may be padded with the zeroes based on the specific sequence in which the inactive antennas are indicated in the first C-plane message. For example, the second beamforming weight information may be represented as “{0, 0; 0, 0; 0, 0; 0.72, 0.76; 0, 0; 0, 0; 0, 0; 0.94, 0.92}” with ‘0.72, 0.76’ and ‘0.94, 0.92’ representing the first beamforming weights for the active antennas, and ‘0, 0’s representing the second beamforming weights for the inactive antennas.

Upon obtaining the second beamforming weight information in the expanded format, the RU 108 may be configured to control the plurality of antennas 204. The plurality of antennas 204 may be controlled based one or more of the first C-plane message 208 or the second beamforming weight information, for example. In various examples, the control of the plurality of antennas 204 may include either activating or deactivating each antenna of the plurality of antennas 204 based on the first C-plane message 208. The activation of an antenna of the plurality of antennas 204 may include changing the antenna from an inactive state to an active state. Alternatively, if the antenna is already in the active state, the activation of the antenna may include maintaining the antenna in the active state. Similarly, the deactivation of the antenna may either include changing the antenna from the active state to the inactive state or maintaining the antenna in the inactive state. In some more examples, the control of the plurality of antennas 204 may include configuring (or assigning) the plurality of antennas 204 with the first beamforming weights and/or the second beamforming weights included in the second beamforming weight information.

Upon controlling the plurality of antennas 204, the RU 108 may be configured to execute the wireless communication with the UE 110. In various examples, the wireless communication may be executed via the active antennas (e.g., the fourth antenna and the eighth antenna) of the plurality of antennas 204. In an example, the execution of the wireless communication with the UE 110 may include communicating, to the UE 110, the data intended for the UE 110 via one or more beams formed by the active antennas. In this way, the RU 108 (and/or the DU 106) may be configured to receive (and/or transmit), via the fronthaul interface, the first C-plane message 208 and the second C-plane message 214 for controlling the plurality of antennas 204.

In further aspects, the RU 108 may be configured to transmit a capability indicator to the DU 106. The capability indicator may be transmitted prior to the reception of the first C-plane message 208. In some examples, the capability indicator may be transmitted at the time of bootup of the RU 108 (and/or the DU 106). In some more examples, the capability indicator may be transmitted via the M-plane message 206. In an example, the capability indicator may correspond to a flag in the M-plane message 206. For example, the capability indicator may indicate a first configured value (e.g., a Boolean value of ‘1’) to specify that the RU 108 supports the first beamforming weight information 216 in the reduced format. Additionally, or alternatively, the capability indicator may indicate a second configured value (e.g., a Boolean value of ‘0’) to specify that the RU 108 does not support the first beamforming weight information 216 in the reduced format.

The transmission of the capability indicator may assist the DU 106 in identifying whether an RU of the O-RAN architecture 100 supports the first beamforming weight information 216 in the reduced format or not. Accordingly, if the O-RAN architecture 100 includes one or more RUs that do not support the first beamforming weight information 216 in the reduced format, the transmission of the capability indicator may enable the DU 106 to communicate, to the one or more RUs, a third C-plane message that includes beamforming weights for both the active antennas and the inactive antennas. Consequently, the transmission of the capability indicator, specifying that the RU supports the first beamforming weight information in the reduced format, may enable the DU 106 to communicate beamforming weights without compromising on the network reliability.

In further aspects, the DU 106 may be configured to transmit a format indicator to the RU 108. In some examples, the format indicator may be transmitted via the first C-plane message 208. In an example, the format indicator may correspond to a flag in the first C-plane message 208. For example, the format indicator may indicate the first configured value to specify that the second C-plane message 214, which follows the first C-plane message 208, comprises the first beamforming weight information 216 in the reduced format. Additionally, or alternatively, the format indicator may indicate the second configured value to specify that the second C-plane message 214 does not comprise the first beamforming weight information 216 in the reduced format. Accordingly, by transmitting the format indicator to the RU 108, the RU 108 can be made aware of whether the second C-plane message 214, which follows the first C-plane message 208, comprises the first beamforming weight information 216 in the reduced format. In other words, the transmission of the format indicator having the first configured value from the DU 106 to the RU 108 may indicate to the RU 108 that in the second C-plane message 214, which follows the first C-plane message 208, the second beamforming weights for the inactive antennas will be absent. Thus, the format indicator having the first configured value may be an indication that the second C-plane message 214, which follows the first C-plane message 208, will only have the first beamforming weights and not the second beamforming weights.

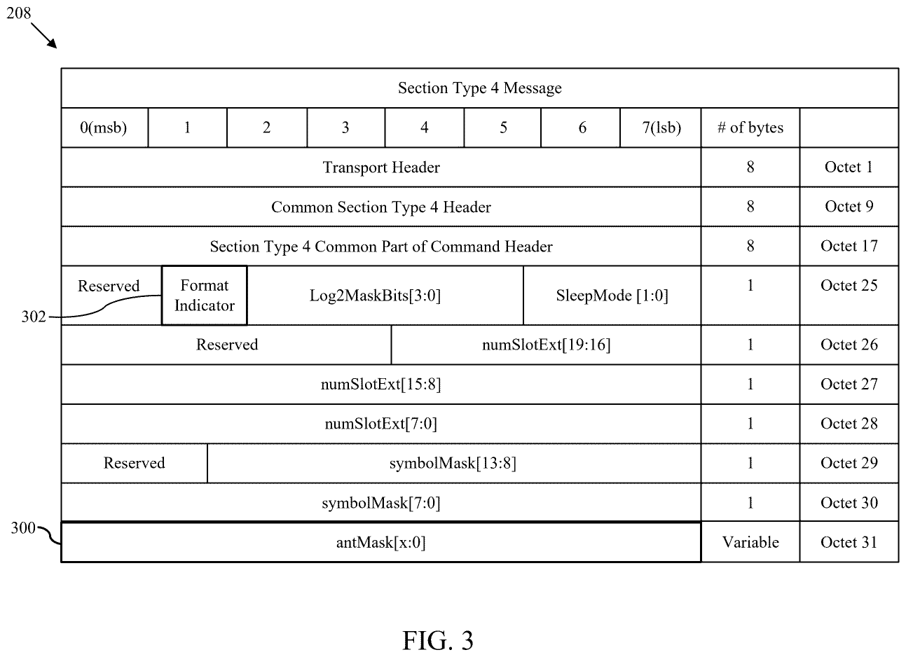

FIG. 3 is a diagram that illustrates an example of the first C-plane message 208, in accordance with certain aspects of the present disclosure. FIG. 3 is explained in conjunction with FIGS. 1 and 2. In numerous examples, the first C-plane message 208 may be transmitted from the DU 106 to the RU 108. In various examples, the first C-plane message 208 may be transmitted by the DU 106 to conserve energy (or block transmission) associated with the antenna array 202. In some examples, the first C-plane message 208 may be transmitted by the DU 106 on a per-slot basis. In these examples, the first C-plane message 208 may be valid for the entire duration of a slot. As used herein, the slot may refer to a fixed time interval, which comprises a plurality of symbols, that enables structured scheduling and resource allocation within a radio frame.

As shown in FIG. 3, the first C-plane message 208 may include a header field that indicates the first C-plane message 208 as the ST4 message. The first C-plane message 208 may further include a transport header, a common ST4 header, and an ST4 common part of command header. The transport header may indicate information related to the first C-plane message 208, such as a message type, transmission source identifier(s), destination identifier(s), sequence number identifier(s), or the like. For example, the transport header may correspond to an enhanced Common Public Radio Interface (eCPRI) transport header. The common ST4 header may indicate a group of one or more endpoints (e.g., one or more antenna arrays of the RU 108) to which the information included in the first C-plane message 208 applies. In some examples, the common ST4 header may also indicate a group of carriers or band sectors to which the first C-plane message 208 applies. The ST4 message may be associated with a plurality of command types, with each command type corresponding to a specific type of information that can be configured in the first C-plane message 208. The ST4 common part of the command header may indicate a standardized portion of the command header that is shared across the plurality of command types in the ST4 message.

In some aspects, the first C-plane message 208 may include an antMask field (also referred to as an antenna mask field) 300. The antMask field 300 may indicate the active antennas of the plurality of antennas 204 and the inactive antenna of the plurality of antennas 204. For example, the antMask field 300 may include (or correspond to) the bitmap 210 that includes the plurality of bits for the plurality of antennas 204, respectively. Each bit of the plurality of bits may either indicate the first value (for example, the Boolean value of ‘1’) or the second value (for example, the Boolean value of ‘0’) to identify the corresponding antenna of the plurality of antennas 204 as either an active antenna or an inactive antenna, respectively. For example, the active antenna may correspond to (or include) a first antenna of the plurality of antennas 204 that is to be activated (or shall remain active). The inactive antenna may correspond to (or include) a second antenna of the plurality of antennas 204 that is to be deactivated (or shall remain inactive).

In some examples, the plurality of bits in the antMask field 300 may be in the specific sequence defined by the positions of the plurality of antennas 204 in the antenna array 202. For example, the MSB may correspond to the leftmost antenna in the first row of the antenna array 202, and the LSB may correspond to the rightmost antenna in the last row of the antenna array 202. Further, the first C-plane message 208 may include a log2MaskBits field. The log2MaskBits field may specify the length of the antMask field 300 in powers of 2. For example, a log 2MaskBits field value of 1 may indicate that the plurality of bits includes 2 bits, a log 2MaskBits field value of 2 may indicate that the plurality of bits includes 4 bits, and so on.

Furthermore, the first C-plane message 208 may include a SleepMode field, one or more numSlotExt fields, and one or more symbolMask fields. The SleepMode field may indicate a sleep mode (e.g., one of “mode 0”, “mode 1”, or the like) associated with a C-plane processing component (e.g., the antMask field 300) of the first C-plane message 208. In various examples, each sleep mode of the sleep modes may be associated with a specific sleep duration interval. The numSlotExt fields may indicate a number of additional slots utilized to extend a configured sleep duration interval to the specific sleep duration interval. The symbolMask fields may indicate a set of symbols, among the plurality of symbols within the slot, that is targeted for a specific operation (e.g., the energy conservation, transmission-blocking, or the like).

In further aspects, the first C-plane message 208 may include a format indicator 302 to specify whether the second C-plane message 214, which follows the first C-plane message 208, comprises beamforming weight information (e.g., the first beamforming weight information 216) in the reduced format. In an example, the format indicator 302 may correspond to the flag in the first C-plane message 208. The format indicator 302 may indicate the first configured value (e.g., the Boolean value of ‘1’) to specify that the second C-plane message 214 comprises the beamforming weight information in the reduced format. Additionally, or alternatively, the format indicator 302 may indicate the second configured value (e.g., the Boolean value of ‘0’) to specify that the second C-plane message 214 does not comprise the beamforming weight information in the reduced format.

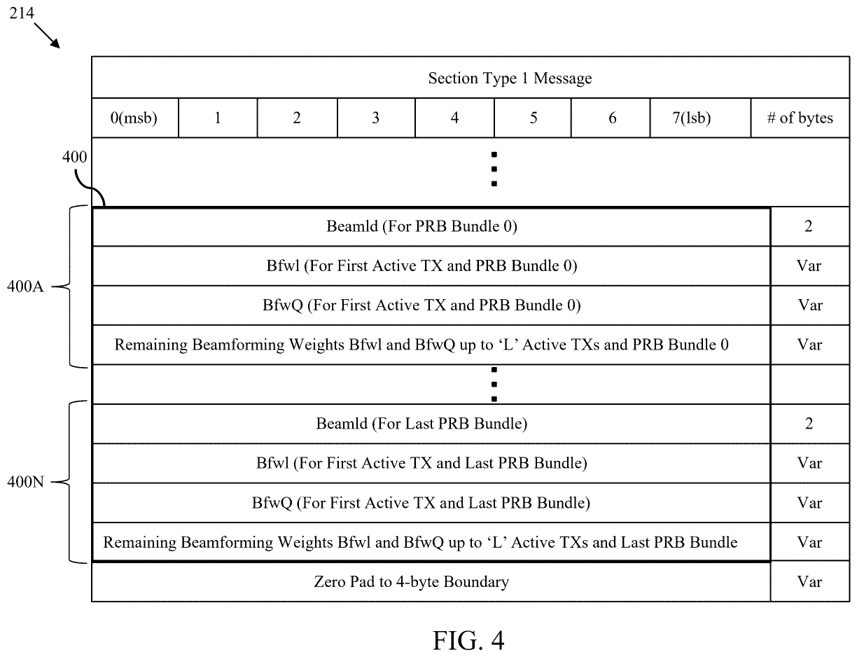

FIG. 4 is a diagram that illustrates an example of the second C-plane message 214, in accordance with certain aspects of the present disclosure. FIG. 4 is explained in conjunction with FIG. 1-3. In numerous examples, the second C-plane message 214 may be transmitted from the DU 106 to the RU 108. In various examples, the second C-plane message 214 may be transmitted by the DU 106 to convey beamforming weight information associated with the antenna array 202. In some examples, the second C-plane message 214 may be transmitted by the DU 106 on a per-slot basis. In these examples, the second C-plane message 214 may be valid for the entire duration of the slot. In some more examples, the slot may include one or more physical resource block (PRB) bundles allocated to one or more communication devices (e.g., the UEs 110). Each PRB bundle of the PRB bundles may include a set of PRBs allocated to a specific communication device of the communication devices with a specific beam identifier.

In some aspects, the second C-plane message 214 may include a header field and one or more sets of beamforming weight fields 400, for example. The header field of the second C-plane message 214 may indicate the second C-plane message 214 as the ST1 message. The sets of beamforming weight fields 400 may include a first set of beamforming weight fields 400A, a second set of beamforming fields, and an n-th set of beamforming fields 400N. Each set of beamforming weight fields of the sets of the beamforming weight fields 400 may include the beam identifier for a respective PRB bundle of the PRB bundles. In an example, the beam identifier is indicated as “BeamId” in FIG. 2.

In further aspects, each set of beamforming weight fields of the sets of the beamforming weight fields 400 may include, for the respective PRB bundle (e.g., PRB bundle 0 or last PRB bundle), ‘L’ first beamforming weights corresponding to ‘L’ active antennas of the plurality of antennas 204. In other words, each set of beamforming weight fields of the sets of the beamforming weight fields 400 may include, for the respective PRB bundle, a first beamforming weight corresponding to each active antenna of the plurality of antennas 204. Each first beamforming weight of the L′ first beamforming weights may represent the set of complex coefficient values (denoted as “Bfwl” and “BfwQ” in FIG. 4) for controlling the respective active antenna of the plurality of antennas 204. For example, for PRB Bundle 0, Bfwl and BfwQ for first active TX, and remaining beamforming weights Bfwl and BfwQ of upto ‘L’ active TXs are included. Similarly, for last PRB Bundle, Bfwl and BfwQ for first active TX, and remaining beamforming weights Bfwl and BfwQ of upto ‘L’ active TXs are included. Furthermore, in the sets of the beamforming weight fields 400, the second beamforming weights corresponding to the inactive antennas of the plurality of antennas 204 may be absent. Accordingly, when the second C-plane message 214 is communicated over the fronthaul interface to the RU 108, the overhead in the fronthaul interface may be reduced.

In some more aspects, in each set of beamforming weight fields of the sets of the beamforming weight fields 400, the ‘L’ first beamforming weights may be included in the same sequence in which the active antennas are indicated within the first C-plane message 208. Consequently, the RU 108 can operate without performing one or more additional processes (e.g., performing a mapping between the first beamforming weights and the active antennas), while controlling the plurality of antennas 204. Accordingly, the demand for the computation resources of the RU 108 may be reduced. The second C-plane message 214 may further include zero paddings that align a length of the second C-plane message 214 align with configured byte boundaries (e.g., 4-byte or 8-byte alignment). In an example, the second C-plane message 214 is shown to include zero pad to 4-byte boundary alignment.

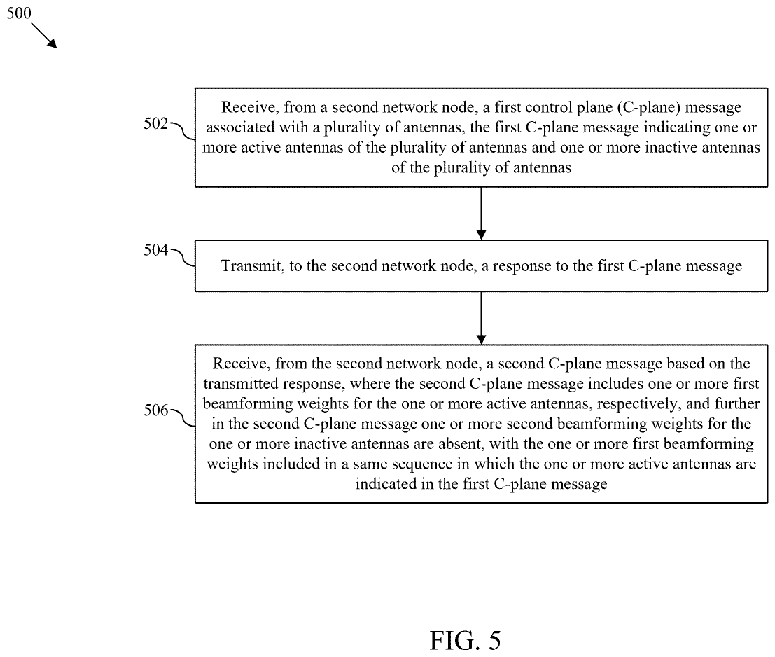

FIG. 5 is a diagram that illustrates a flowchart of a process (e.g., a method) 500 for receiving one or more C-plane messages, in accordance with certain aspects of the present disclosure. FIG. 5 is explained in conjunction with FIG. 1-4. In various examples, the process 500 may be implemented by a first network node (e.g., the RU 108) to receive the C-plane messages (e.g., the first C-plane message 208 and/or the second C-plane message 214) from a second network node (e.g., the DU 106).

At 502, the first C-plane message 208 associated with the plurality of antennas 204 may be received by the first network node from the second network node. The first C-plane message 208 may indicate the one or more active antennas of the plurality of antennas 204 and the one or more inactive antennas of the plurality of antennas 204. For example, an active antenna of the active antennas may correspond to a first antenna of the plurality of antennas 204 that is to be activated (or shall remain active) while performing the wireless communication. In an example, an inactive antenna of the inactive antennas may correspond to a second antenna of the plurality of antennas 204 that is to be deactivated (or shall remain inactive) while performing the wireless communication. In numerous examples, the first network node may receive the first C-plane message 208 from the second network node via the fronthaul interface. In some examples, the first C-plane message 208 may correspond to the ST4 message that is used to configure or manage the wireless communication.

At 504, the response 212 may be transmitted for the first C-plane message 208 to the second network node. In numerous examples, the first network node may transmit, to the second network node, the response 212 based on the reception of the first C-plane message 208. In some examples, if the first C-plane message 208 is received completely, the first network node may transmit the response 212 to the second network node. In some more examples, the response 212 may correspond to a Section Type 8 (ST8) message. In an example, the response 212 may include the ACK indicating that the reception of the first C-plane message 208 was successful. In further examples, the response 212 may be utilized by the second network node to generate (and/or transmit) the second C-plane message 214. In an example, the transmission of the response 212 may trigger the second network node to generate (and/or transmit) the second C-plane message 214.

At 506, the second C-plane message 214 may be received from the second network node based on the transmitted response 212. The second C-plane message 214 may include (or indicate) the one or more first beamforming weights for the one or more active antennas, respectively. Further, in the second C-plane message 214, the one or more second beamforming weights for the one or more inactive antennas may be absent. Furthermore, in the second C-plane message 214, the first beamforming weights may be included in the same sequence in which the one or more active antennas are indicated in the first C-plane message 208. In numerous examples, the first network node may receive the second C-plane message 214 from the second network node via the fronthaul interface. In some examples, the second C-plane message 214 may correspond to the ST1 message that is used to convey the configurational details for the beamforming.

In this way, the process 500 may configure the first network node to receive the first C-plane message 208 and/or the second C-plane message 214 from the second network node. Further, since the second beamforming weights for the inactive antennas are not received through the second C-plane message 214, the reception of the second C-plane message 214 may enable the first network node to reduce the overhead in the fronthaul. Furthermore, since the first beamforming weights in the second C-plane message 214 are included in the same sequence in which the active antennas are indicated in the first C-plane message 208, the reception of the second C-plane message 214 may enable the first network node to avoid performing the additional processes, such as performing the mapping between the first beamforming weights and the active antennas, determining which weight among the first beamforming weights corresponds to an antenna of the plurality of antennas, or the like. Consequently, reducing the demand for the computation resources of the first network node.

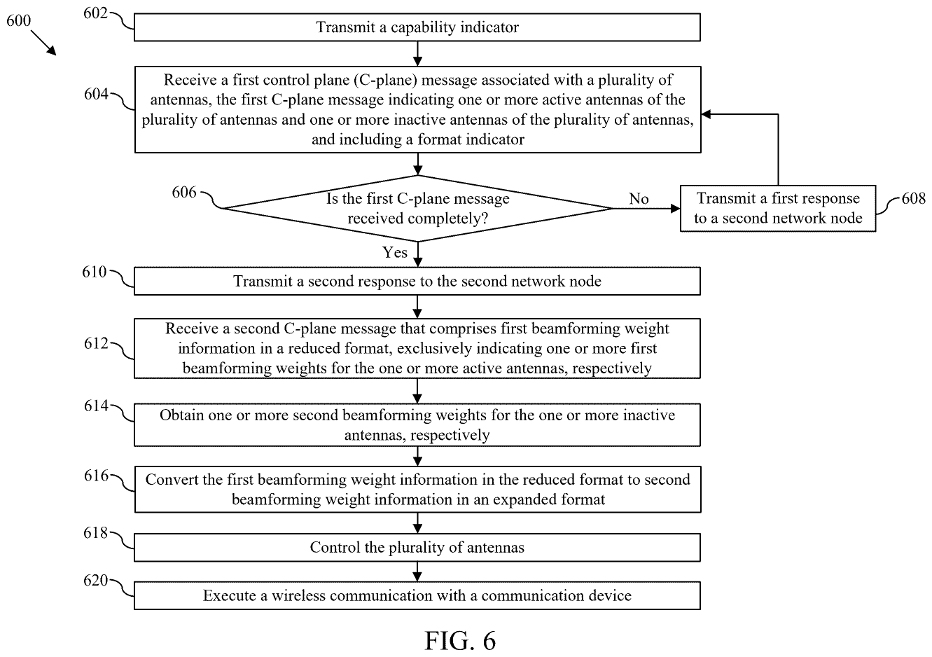

FIG. 6 is a diagram that illustrates a flowchart of a process (e.g., a method) 600 for executing the wireless communication, in accordance with certain aspects of the present disclosure. FIG. 6 is explained in conjunction with FIG. 1-4. In various examples, the process 600 may be implemented by a first network node (e.g., the RU 108) to execute the wireless communication with a communication device (e.g., the UE 110).

At 602, the capability indicator may be transmitted. In numerous examples, the first network node may transmit the capability indicator to a second network node (e.g., the DU 106). In some examples, the capability indicator may be transmitted via the M-plane message 206. In some more examples, the capability indicator may correspond to the flag in the M-plane message 206. For example, the capability indicator may indicate the first configured value (e.g., the Boolean value of ‘1’) to specify that the first network node supports the first beamforming weight information 216 in the reduced format. Additionally, or alternatively, the capability indicator may indicate the second configured value (e.g., the Boolean value of ‘0’) to specify that the first network node does not support the first beamforming weight information 216 in the reduced format.

At 604, the first C-plane message 208 associated with the plurality of antennas 204 may be received. The first C-plane message 208 may indicate the one or more active antennas of the plurality of antennas 204 and the one or more inactive antennas of the plurality of antennas 204, and also include the format indicator 302. In numerous examples, the first network node may receive, from the second network node, the first C-plane message 208 subsequent to the transmission of the capability indicator. In other words, the transmission of the capability indicator may be prior to the reception of the first C-plane message 208. In an example, the format indicator 302 may correspond to the flag in the first C-plane message 208. For example, the format indicator 302 may indicate the first configured value to specify that the second C-plane message 214, which follows the first C-plane message 208, comprises the first beamforming weight information 216 in the reduced format. Additionally, or alternatively, the format indicator 302 may indicate the second configured value to specify that the second C-plane message 214 does not comprise the first beamforming weight information 216 in the reduced format.

At 606, the determination of whether the first C-plane message 208 has been received completely is performed. In numerous examples, the first network node may determine whether the first C-plane message 208 has been received completely. In some more examples, the first network node may perform the verification/validation process(es) on the first C-plane message 208 to determine whether the first C-plane message 208 has been received completely. In an example, the verification/validation process(es) may include the checksum validation process, the length verification process, or the like.

In some aspects, if the first C-plane message 208 has not been received completely, a first response may be transmitted, at 608. In numerous examples, the first network node may transmit the first response to the second network node. In some examples, the first response may include the NCK that indicates the reception of the first C-plane message 208 was unsuccessful. In some more aspects, upon transmitting the first response, the first C-plane message 208 may be again received from the second network node, at 604.

In further aspects, if the first C-plane message 208 has been received completely, a second response may be transmitted, at 610. In numerous examples, the first network node may transmit the second response to the second network node. In some examples, the second response may correspond to the response 212 that includes the ACK. The ACK may indicate that the reception of the first C-plane message 208 was successful. In some more examples, the second response may be utilized by the second network node to generate (and/or transmit) the second C-plane message 214.

At 612, the second C-plane message 214 may be received. The second C-plane message 214 may comprise the first beamforming weight information 216 in the reduced format. The first beamforming weight information 216 in the reduced format may exclusively indicate the one or more first beamforming weights for the one or more active antennas, respectively. In numerous examples, the first network node may receive the second C-plane message 214 from the second network node. Thus, the first beamforming weight information 216 may not indicate the second beamforming weights for the inactive antennas. In further examples, the first beamforming weights may be indicated in the same sequence in which the active antennas are indicated in the first C-plane message 208.

At 614, the one or more second beamforming weights for the one or more inactive antennas, respectively, may be obtained. In numerous examples, the first network node may obtain the second beamforming weights for the inactive antennas, respectively. In an example, each beamforming weight of the obtained second beamforming weights may represent the set of configured complex coefficient values (e.g., “0, 0”).

At 616, the first beamforming weight information 216 in the reduced format may be converted to the second beamforming weight information in the expanded format. In numerous examples, the first network node may convert, based on the obtained second beamforming weights, the first beamforming weight information 216 in the reduced format to the second beamforming weight information in the expanded format. In some examples, the conversion of the first beamforming weight information 216 to the second beamforming weight information may comprise adding the obtained second beamforming weights to the first beamforming weight information 216. In some more examples, the obtained second beamforming weights may be added to the first beamforming weight information 216 based on the specific sequence in which the inactive antennas are indicated in the first C-plane message 208. Thus, each of the first beamforming weights in the second beamforming weight information is at the same indexed position at which a corresponding active antenna of the one or more active antennas is indicated in the first C-plane message 208. Further, each of the second beamforming weights in the second beamforming weight information is at the same indexed position at which a corresponding inactive antenna of the inactive antennas is indicated in the first C-plane message 208. In further examples, the addition of the obtained second beamforming weights to the first beamforming weight information 216 may include padding the first beamforming weights in the first beamforming weight information 216 with zeroes, where the zeroes can correspond to the obtained second beamforming weights.

At 618, the plurality of antennas 204 may be controlled. In numerous examples, the first network node may control the plurality of antennas 204 based on at least one of the first C-plane message 208 or the second beamforming weight information. In some examples, the control of the plurality of antennas 204 may include either activating or deactivating each antenna of the plurality of antennas 204 based on the first C-plane message 208. In an example, a specific antenna of the plurality of antennas 204 may be activated, if a specific bit corresponding to the specific antenna in the first C-plane message 208 indicates the first value. In contrast, if the specific bit in the first C-plane message 208 indicates the second value, the specific antenna may be deactivated. In some more examples, the control of the plurality of antennas 204 may include configuring (or assigning) the plurality of antennas 204 with the first beamforming weights and/or the second beamforming weights included in the second beamforming weight information.

At 620, the wireless communication may be executed with the communication device. In numerous examples, the first network node may execute the wireless communication with the UE 110. In some examples, the wireless communication may be executed via the active antennas of the plurality of antennas 204. In some more examples, the execution of the wireless communication may comprise communicating, to the UE 110, the data intended for the UE 110 via the one or more beams formed by the active antennas.

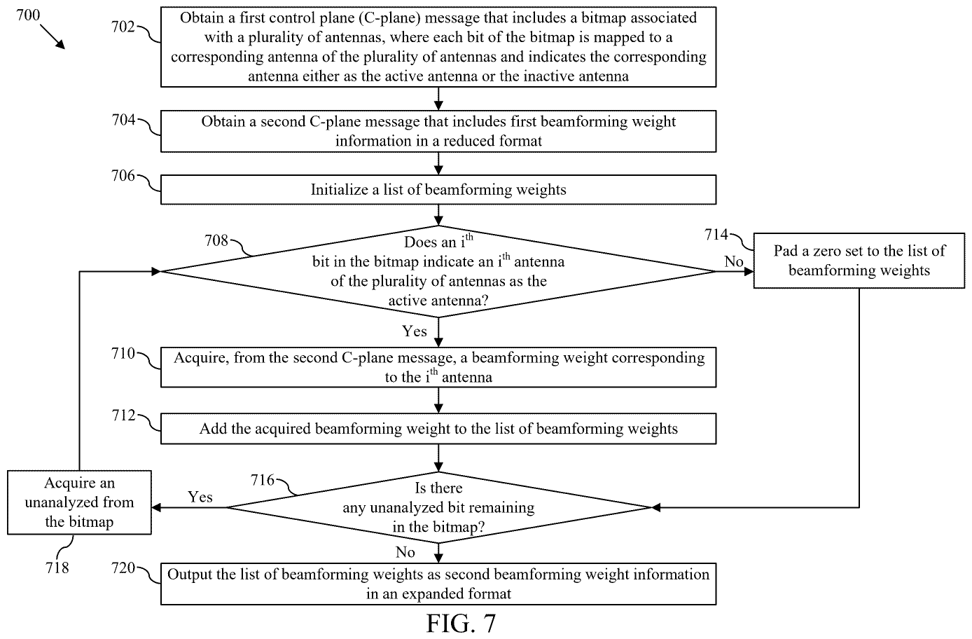

FIG. 7 is a diagram that illustrates a flowchart of a process (e.g., a method) 700 for converting the first beamforming weight information 216 to the second beamforming weight information, in accordance with certain aspects of the present disclosure. FIG. 7 is explained in conjunction with FIG. 1-4. In various examples, the process 700 may be implemented by a first network node (e.g., the RU 108) to convert the first beamforming weight information 216 to the second beamforming information.

At 702, the first C-plane message 208 may be obtained. The first C-plane message 208 may include a bitmap (e.g., the bitmap 210) associated with the plurality of antennas 204. Each bit of the bitmap 210 may be mapped to a corresponding antenna of the plurality of antennas 204. Further, each bit of the bitmap 210 may indicate the corresponding antenna either as the active antenna or the inactive antenna. In numerous examples, the first network node may obtain the first C-plane message 208, for example, by receiving from a second network node (e.g., the DU 106).

At 704, the second C-plane message 214 may be obtained. In some examples, the second C-plane message 214 may include the first beamforming weight information 216 in the reduced format. In some more examples, the first beamforming weight information 216 may exclusively indicate the first beamforming weights for the active antennas of the plurality of antennas 204. In numerous examples, the first network node may receive the second C-plane message 214, for example, by receiving from the second network node.

At 706, a list of beamforming weights may be initialized. In numerous examples, the first network node may initialize the list of beamforming weights. In some examples, the list of beamforming weights may be initialized such that the list of beamforming weights can include a specific number of elements. In an example, the specific number may correspond to a count of bits in the bitmap 210. In some more examples, the initialized list of beamforming weights may correspond to an empty list.

At 708, determination of whether an i^{th} bit in the bitmap 210 indicates an i^{th} antenna of the plurality of antennas 204 as the active antenna may be performed. In numerous examples, the first network node may determine whether the i^{th} bit in the bitmap 210 indicates the i^{th} antenna of the plurality of antennas 204 as the active antenna. As used herein, the i^{th} bit may correspond to a bit of the bitmap 210 that is indexed at an i^{th} position in the bitmap 210. For example, the i^{th} position may correspond to one of a 0^{th} position, a 1^{st} position, or the like. As used herein, the i^{th} antenna may correspond to an antenna, of the plurality of antennas 204, corresponding to the i^{th} bit. In an example, if the i^{th} bit corresponds to the first value, the first network node may determine that the i^{th} bit indicates the i^{th} antenna as the active antenna. Conversely, if the i^{th} bit corresponds to the second value, the first network node may determine that the i^{th} bit does not indicate the i^{th} antenna as the active antenna. In other words, if the i^{th} bit corresponds to the second value, the first network node may determine that the i^{th} bit indicates the i^{th} antenna as the inactive antenna.

In some aspects, if the i^{th} bit indicates the i^{th} antenna as the active antenna, a beamforming weight corresponding to the i^{th} antenna may be acquired from the second C-plane message 214, at 710. In numerous examples, the first network node may acquire the beamforming weight corresponding to the i^{th} antenna from the second C-plane message 214. In an example, the beamforming weight corresponding to the i^{th} antenna may be acquired from the first beamforming weight information 216 included in the second C-plane message 214.

At 712, the acquired beamforming weight may be added to the list of beamforming weights. In numerous examples, the first network node may add the acquired beamforming weight to the list of beamforming weights. In some examples, the addition of the acquired beamforming weight may include indexing or appending the acquired beamforming weight in the list of beamforming weights at the i^{th} position.

In some more aspects, if the i^{th} bit indicates the i^{th} antenna as the inactive antenna, a zero set (e.g., “0, 0”) may be padded to the list of beamforming weights, at 714. In numerous examples, the first network node may pad the zero set to the list of beamforming weights. In some examples, the padding of the zero set may include indexing or appending the zero set in the list of beamforming weights at the i^{th} position.

At 716, a determination of whether any unanalyzed bit remains in the bitmap 210 may be performed. In numerous examples, the first network node may determine whether any unanalyzed bit remains in the bitmap 210. In some examples, if one or more unanalyzed bits remain in the bitmap 210, an unanalyzed bit (e.g., a next i^{th} bit, an i+1^{th} bit, or the like) may be acquired from the bitmap 210, at 718. In numerous examples, the first network node may acquire the unanalyzed bit from the bitmap 210. In further examples, the determination of whether the unanalyzed bit indicates an antenna corresponding to the unanalyzed bit as the active antenna may be performed, at 708.

Conversely, if all bits in the bitmap 210 are analyzed, the list of beamforming weights may be outputted as the second beamforming weight information in the expanded format, at 720. In numerous examples, the first network node may output the list of beamforming weights as the second beamforming weight information. In some examples, the second beamforming weight information may be in the expanded format that indicates one or more added beamforming weights and one or more padded zero sets. The added beamforming weights may respectively correspond to the first beamforming weights and the padded zero sets may respectively correspond to the second beamforming weights.

In this way, if the first network node receives, via the second C-plane message 214, the first beamforming weight information 216 that does not indicate the second beamforming weights, the process 700 may configure the first network node to convert the first beamforming weight information 216 from the reduced to the second beamforming weight information in the expanded format. Thus, enabling the first network node to support the reception of the first beamforming weight information 216 in the reduced format, which in turn enables the first network node to reduce the overhead in the fronthaul interface. Consequently, leading to improvements in network performances, such as network latency, network bandwidth, or the like.

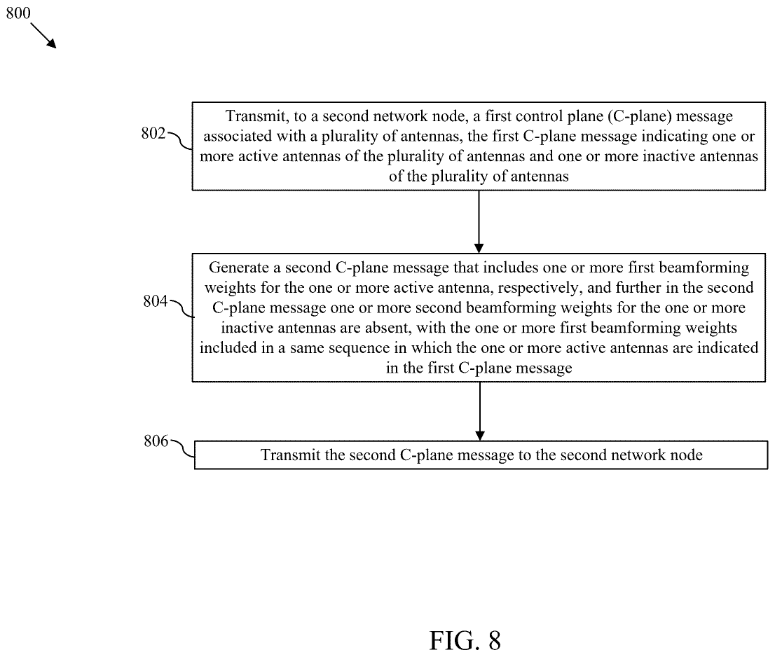

FIG. 8 is a diagram that illustrates a high-level flowchart of a process (e.g., a method) 800 for transmitting one or more C-plane messages, in accordance with certain aspects of the present disclosure. FIG. 8 is explained in conjunction with FIG. 1-4. In various examples, the process 800 may be implemented by a first network node (e.g., the DU 106) to transmit the C-plane messages (e.g., the first C-plane message 208 and/or the second C-plane message 214) to a second network node (e.g., the RU 108).

At 802, the first C-plane message 208 associated with the plurality of antennas 204 may be transmitted to the second network node. The first C-plane message 208 may indicate the one or more active antennas of the plurality of antennas 204 and the one or more inactive antennas of the plurality of antennas 204. In numerous examples, the first network node may transmit the first C-plane message 208 to the second network node via the fronthaul interface. In some more examples, the first C-plane message 208 may include the bitmap 210 having the plurality of bits for the plurality of antennas 204, respectively. The plurality of bits may include the first set of bits, each with the first value (for example, the Boolean value of ‘1’), indicating the active antennas of the plurality of antennas 204. The plurality of bits may further include the second set of bits, each with the second value (for example, the Boolean value of ‘0’), indicating the inactive antennas of the plurality of antennas 204.

At 804, the second C-plane message 214 may be generated. In some examples, the second C-plane message 214 may include the one or more first beamforming weights for the one or more active antennas of the plurality of antennas 204, respectively. Further, in the second C-plane message 214, the one or more second beamforming weights for the one or more inactive antennas of the plurality of antennas 204, respectively, may be absent. In the second C-plane message 214, the first beamforming weights may be included in the same sequence in which the active antennas are indicated in the first C-plane message 208. In other words, the second C-plane message 214 may not indicate (or include) the one or more second beamforming weights for the one or more inactive antennas of the plurality of antennas 204, respectively. In numerous examples, the first network node may generate the second C-plane message 214.

At 806, the second C-plane message 214 may be transmitted to the second network node. In numerous examples, the first network node may transmit the second C-plane message 214 to the second network node. In some examples, the second C-plane message 214 may be transmitted via the fronthaul interface. In some examples, the transmission of the second C-plane message 214 may enable the second network node to control the plurality of antennas 204 for performing the wireless communication with the UE 110.

In this way, the process 800 may configure the first network node to transmit the first C-plane message 208 and/or the second C-plane message 214 to the second network node. Further, since the second beamforming weights for the inactive antennas are not communicated to the second network node via the fronthaul interface, the transmission of the second C-plane message 214 may enable the first network node to reduce the overhead in the fronthaul interface. Furthermore, since the first beamforming weights in the second C-plane message 214 are included in the same sequence in which the active antennas are indicated in the first C-plane message 208, the transmission of the second C-plane message 214 may enable the second network node to avoid performing one or more additional processes (e.g., performing the mapping between the first beamforming weights and the active antennas). Consequently, reducing the demand for the computation resources of the second network node.

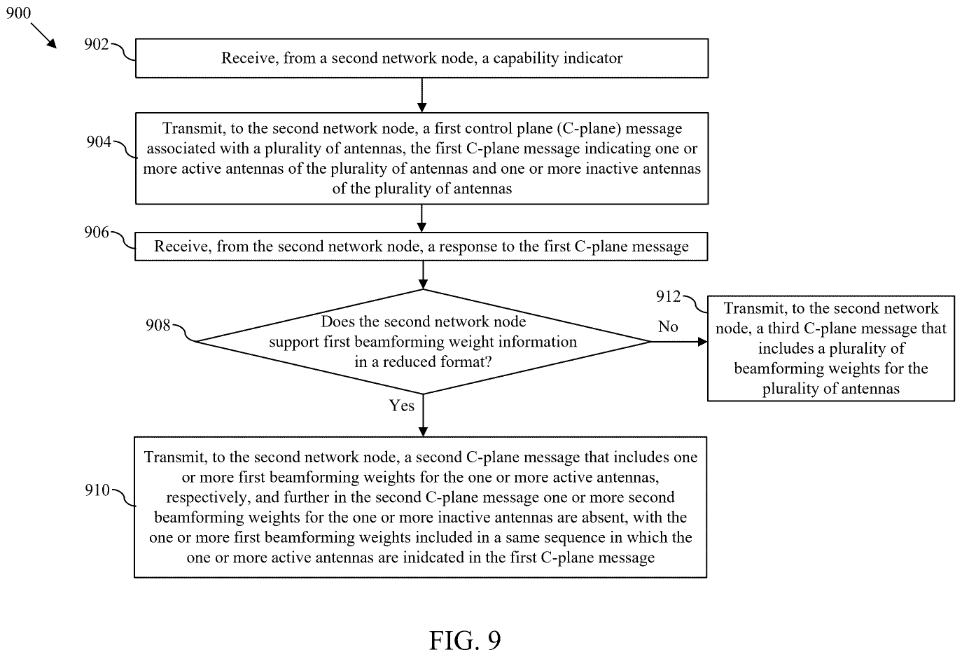

FIG. 9 is a diagram that illustrates a detailed flowchart of a process (e.g., a method) 900 for transmitting one or more C-plane messages, in accordance with certain aspects of the present disclosure. FIG. 9 is explained in conjunction with FIG. 1-4. In various examples, the process 900 may be implemented by a first network node (e.g., the DU 106) to transmit the C-plane messages (e.g., the first C-plane message 208, the second C-plane message 214, and/or the third C-plane message) to a second network node (e.g., the RU 108).

At 902, the capability indicator may be received from the second network node. In numerous examples, the first network node may receive the capability indicator from the second network node. In some examples, the capability indicator may be received via the M-plane message 206. In some more examples, the capability indicator may specify whether the second network node supports the first beamforming weight information 216 in the reduced format.

At 904, the first C-plane message 208 associated with the plurality of antennas 204 may be transmitted to the second network node. The first C-plane message 208 may indicate the one or more active antennas of the plurality of antennas 204 and the one or more inactive antennas of the plurality of antennas 204. In numerous examples, the first network node may transmit the first C-plane message 208 to the second network node. In some more examples, the transmission of the first C-plane message 208 may enable the second network node to control the plurality of antennas 204. In an example, the control of the plurality of antennas 204 may include either activating or deactivating each antenna of the plurality of antennas 204 based on the first C-plane message 208.

At 906, the response 212 may be received for the first C-plane message 208 from the second network node. In numerous examples, the first network node may receive, from the second network node, the response 212 for the first C-plane message 208. In some examples, the response 212 may include the ACK. The ACK may indicate that the reception of the first C-plane message 208 was successful.

At 908, a determination of whether the second network node supports the first beamforming weight information 216 in the reduced format may be performed. In numerous examples, the first network node may determine, based on the capability indicator, whether the second network node supports the first beamforming weight information 216 in the reduced format. In an example, if the capability indicator indicates the first configured value, the first network node may determine that the second network node supports the first beamforming weight information 216 in the reduced format. Conversely, if the capability indicator indicates the second configured value, the first network node may determine that the second network node does not support the first beamforming weight information 216 in the reduced format.

In some aspects, if the second network node supports the first beamforming weight information 216 in the reduced format, the second C-plane message 214 may be transmitted to the second network node, at 910. The second C-plane message 214 may include the one or more first beamforming weights for the one or more active antennas of the plurality of antennas 204, respectively. Further, in the second C-plane message 214, the one or more second beamforming weights for the one or more inactive antennas may be absent. Furthermore, in the second C-plane message 214, the one or more first beamforming weights may be included in the same sequence in which the one or more active antennas are indicated in the first C-plane message 208. In some examples, the second C-plane message 214 may include the first beamforming weight information 216 in the reduced format. In numerous examples, the first network node may transmit the second C-plane message 214 to the second network node.

In some more aspects, if the second network node does not support the first beamforming weight information 216 in the reduced format, the third C-plane message may be transmitted to the second network node. The third C-plane message may include the plurality of beamforming weights for the plurality of antennas, respectively. In other words, the third C-plane message may include the first beamforming weights for the active antennas and also the second beamforming weights for the inactive antennas. In numerous examples, the first network node may transmit the third C-plane message to the second network node.

In this way, the process 900 may configure the first network node to transmit, based on the capability indicator, the second C-plane message 214 or the third C-plane message to the second network node. Accordingly, the first network node may transmit the second C-plane message 214 to the second network node only if the second network node supports the first beamforming weight information 216 in the reduced format. On the contrary, if the second network node does not support the first beamforming weight information 216 in the reduced format, the first network node may transmit the third C-plane message to the second network node. Consequently, the reception of the capability indicator may enable the first network node to improve the network reliability of the wireless communication network in which the first network node is operated.

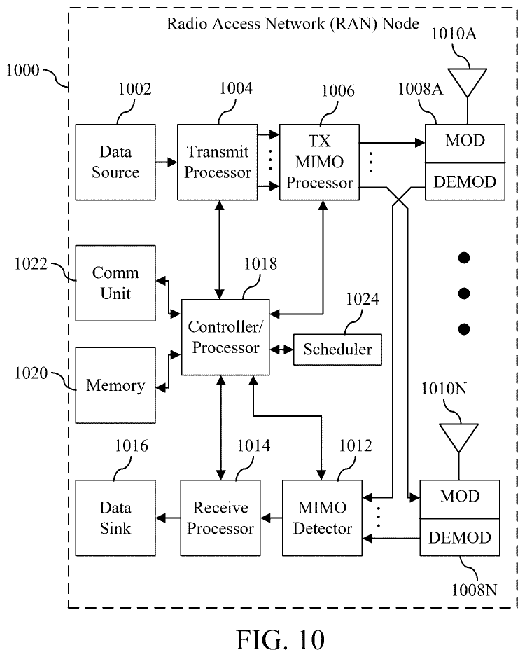

FIG. 10 is a diagram that illustrates an example of a RAN node 1000, in accordance with certain aspects of the present disclosure. FIG. 10 is explained in conjunction with FIG. 1-9. The RAN node 1000 may facilitate wireless communication with a different RAN node and/or one or more communication devices (e.g., the UEs 110). In some examples, the RAN node 1000 may correspond to the NR base station, the LTE base station, the eNB, the gNB, the access point, the TRP, or the like.

In some aspects, the RAN node 1000 may include a data source 1002 and/or a transmit processor 1004. The data source 1002 may be configured to generate data intended for a destination device, such as a different RAN node, the UEs 110, or the like. Further, the data source 1002 may output the generated data to the transmit processor 1004. The transmit processor 1004 may be configured to select one or more modulation and coding schemes (MCSs) for the destination device based on channel quality indicators (CQIs) received from the destination device. Further, the transmit processor 1004 may be configured to perform one or more processes (e.g., an encoding process, a modulation process, or the like) on the generated data using the selected MCSs. In some examples, the processes may be performed on the generated data to produce a plurality of data symbols for the destination device.

In some examples, the transmit processor 1004 may also process system information (e.g., semi-static resource partitioning information “SRPI”) and/or control information (e.g., channel quality indicator (CQI) requests, grants, or upper-layer signaling) to produce one or more overhead symbols and/or control symbols, respectively. In some more examples, the transmit processor 1004 may also produce one or more reference symbols for one or more reference signals or one or more synchronization signals. In an example, the reference signals may include a cell-specific reference signal (CRS), a demodulation reference signal (DMRS), or the like. For example, the synchronization signals may include a primary synchronization signal (PSS), a secondary synchronization signal (SSS), or the like.

In some more aspects, the RAN node 1000 may include a transmit (TX) Multiple-Input Multiple-Output (MIMO) processor 1006, a plurality of modems 1008A 1008N (e.g., ‘N’ modems, where N>1), and/or a plurality of antennas 1010A-1010N (e.g., ‘N’ antennas). The TX MIMO processor 1006 may be configured to perform spatial processing (e.g., precoding) on one or more of the data symbols, the overhead symbols, the control symbols, or the reference symbols. In some examples, the spatial processing may be performed to produce a plurality of output symbol streams (e.g., ‘N’ output symbol streams). Further, the TX MIMO processor 1006 may be configured to output the plurality of output symbol streams to the plurality of modems 1008A-1008N. In some aspects, the plurality of modems 1008A-1008N and the plurality of antennas 1010A-1010N may be optional or external to the RAN node 1000 depending on the functionality of the RAN node 1000.

Each modem of the plurality of modems 1008A-1008N may be configured to receive a respective output symbol stream of the plurality of output symbol streams. Each modem of the plurality of modems 1008A-1008N may include a modulator component (denoted as “MOD” in FIG. 10) and a demodulator component (denoted as “DEMOD” in FIG. 10). In some examples, the modulator component of each modem may be configured to receive the respective output symbol stream. Further, each modem (e.g., the modulator component) of the plurality of modems 1008A-1008N may be configured to process the respective output symbol stream to produce a first wireless signal. Consequently, the plurality of modems 1008A-1008N may produce a plurality of first wireless signals (e.g., a plurality of downlink signals), respectively. Furthermore, the plurality of modems 1008A-1008N may be configured to transmit the plurality of first wireless signals via the plurality of antennas 1010A-1010N.

The plurality of antennas 1010A-1010N may be configured to transmit the plurality of first wireless signals to the destination device. In some examples, the plurality of antennas 1010A-1010N may include patch antennas, dipole antennas, or the like. In some more examples, the plurality of antennas 1010A-1010N may be provided within one or more antenna arrays, one or more antenna panels, or the like. In further examples, the plurality of antennas 1010A-1010N may include (or correspond to) the plurality of antennas 204 described in the detailed description of FIG. 2.

In some aspects, the plurality of antennas 1010A-1010N may be configured to receive, from the destination device, a plurality of second wireless signals (e.g., a plurality of uplink signals). The plurality of second wireless signals may be processed by the plurality of modems 1008A-1008N. In some examples, the demodulator component of each modem of the plurality of modems 1008A-1008N may be configured to process a respective second wireless signal of the plurality of second wireless signals.

In further aspects, the RAN node 1000 may include a MIMO detector 1012, a receive processor 1014, a data sink 1016, a controller/processor 1018, and/or a memory 1020. The MIMO detector 1012 may detect the plurality of second wireless signals processed by the plurality of modems 1008A-1008N. The receive processor 1014 may process the detected plurality of second wireless signals to produce decoded data and/or decoded control information. Further, the receive processor 1014 may output the decoded data and/or the decoded control information to the data sink 1016 and/or the controller/processor 1018, respectively. Additionally, the RAN node 1000 may include a communication unit 1022 and/or a scheduler 1024. The communication unit 1022 may correspond to a communication interface that facilitates the RAN node 1000 to communicate to one or more external controllers, such as a network controller, or the like. The scheduler 1024 may correspond to an uplink scheduler and/or a downlink scheduler that facilitates the RAN node 1000 to schedule uplink communications and downlink communications, respectively.

In some aspects, the controller/processor 1018 may include suitable circuitry, interfaces, and/or logic configured to perform one or more transmitting functions, one or more receiving functions, and one or more processing functions for the RAN node 1000. Examples of the processing functions may include processing signals received and/or to be transmitted by the RAN node 1000. In various aspects, the controller/processor 1018 may be implemented with a bus architecture, represented generally by a bus. The bus may include any number of interconnecting buses and bridges depending on the specific application of the controller/processor 1018 and the overall design constraints. The bus may provide an interface between the controller/processor 1018 and the other components of the RAN node 1000. For example, the bus may communicatively couple the controller/processor 1018 and the memory 1020.

Examples of the controller/processor 1018 may include, but are not limited to system on a chip (SoC) processors, embedded processors, microcontrollers, specialized Digital Signal Processors (DSPs), Reduced Instruction Set Computing (RISC) processors, Application-Specific Integrated Circuit (ASIC) processors, field-programmable gate arrays (FPGAs), central processing units (CPUs), explicitly parallel instruction computing (EPIC) processors, very long instruction word (VLIW) processors, programmable logic devices (PLDs), state machines, gated logic, discrete hardware circuits, and other suitable processors or circuits configured to perform the various functionality described throughout this disclosure. In further aspects, the controller/processor 1018 may be implemented via a baseband or modem chip. In additional implementations, the controller/processor 1018 may comprise a number of devices distinct and different from the baseband or modem chip.

In some aspects, the controller/processor 1018 may be communicatively coupled to the memory 1020 (e.g., computer-readable medium/memory). The memory 1020 may include suitable circuitry, interfaces, and/or logic configured to store instructions (e.g., computer-executable code) that when executed by the controller/processor 1018 may cause the controller/processor 1018 to perform the operations illustrated in FIG. 1-9, or additional operations to optimize a C-plane message for antenna control. The RAN node 1000 may store data within the memory 1020 by transforming the physical state of one or more physical storage units (e.g., transistors, magnetic domains, optical pits, gate cells, phase change materials, etc.) in the memory 1020 to reflect the information being stored. The specific transformation of physical state can depend on various factors. Examples of such factors can include, but are not limited to, the technology used to implement the physical storage units, whether the memory 1020 is characterized as primary or secondary storage, and the like.

In further aspects, the memory 1020 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

In some implementations, the RAN node 1000 may be configured to operate as the DU 106 and/or the RU 108 described herein. In some more implementations, the DU 106 and/or the RU 108 described herein may correspond to (or may be included in) the RAN node 1000. For example, the controller/processor 1018 or any other components of the RAN node 1000 may enable the RAN node 1000 to perform the operations of one or more processes (e.g., the processes 500-900) described herein.

In some aspects, when the RAN node 1000 corresponds to a first network node (e.g., the RU 108), the controller/processor 1018 or any other components of the RAN node 1000 may be configured to receive, from a second network node (e.g., the DU 106), the first C-plane message 208 associated with the plurality of antennas 204. In some examples, the first C-plane message 208 may indicate the active antennas of the plurality of antennas 204 and the inactive antennas of the plurality of antennas 204. Further, the controller/processor 1018 or any other components of the RAN node 1000 may be configured to transmit, to the second network node, the response 212 to the first C-plane message 208. Furthermore, the controller/processor 1018 or any other components of the RAN node 1000 may be configured to receive, from the second network node, the second C-plane message 214 based on the response 212. In some examples, the second C-plane message 214 may include the first beamforming weights for the active antennas, respectively. In further examples, in the second C-plane message 214, the second beamforming weights for the inactive antennas may be absent. In furthermore examples, in the second C-plane message 214, the first beamforming weights may be included in the same sequence in which the active antennas are indicated in the first C-plane message 208.

In some more aspects, when the RAN node 1000 corresponds to a first network node (e.g., the DU 106), the controller/processor 1018 or any other components of the RAN node 1000 may be configured to transmit, to a second network node (e.g., the RU 108), the first C-plane message 208 associated with the plurality of antennas 204. In some examples, the first C-plane message 208 may indicate the active antennas of the plurality of antennas 204 and the inactive antennas of the plurality of antennas 204. Further, the controller/processor 1018 or any other components of the RAN node 1000 may be configured to generate the second C-plane message 214 that includes the first beamforming weights for the active antennas, respectively. In some examples, in the second C-plane message 214, the second beamforming weights for the inactive antennas may be absent. In some more examples, in the second C-plane message 214, the first beamforming weights may be included in the same sequence in which the active antennas are indicated in the first C-plane message 208. Furthermore, the controller/processor 1018 or any other components of the RAN node 1000 may be configured to transmit the second C-plane message 214 to the second network node.

Accordingly, by transmitting (and/or receiving) the second C-plane message 214 that is optimized to not indicate the second beamforming weights for the inactive antennas, the overhead in the fronthaul may be reduced. Further, since the first beamforming weights in the second C-plane message 214 are included in the same sequence in which the active antennas are indicated in the first C-plane message 208, the transmission (and/or the reception) of the second C-plane message 214 may enable the RU 108 to not perform one or more additional processes, such as performing the mapping between the first beamforming weights and the active antennas, determining which weight among the first beamforming weights corresponds to an antenna of the plurality of antennas, or the like. Consequently, the demand for the computation resources of the RU 108 may be reduced.

Some implementation examples are described in the following numbered aspects:
Aspect 1: A method for wireless communication at a first network node, the method comprising receiving, from a second network node, a first control plane (C-plane) message associated with a plurality of antennas. The first C-plane message indicates one or more active antennas of the plurality of antennas and one or more inactive antennas of the plurality of antennas. The method further comprises transmitting, to the second network node, a response to the first C-plane message; and receiving, from the second network node, a second C-plane message based on the transmitted response. The second C-plane message includes one or more first beamforming weights for the one or more active antennas, respectively. In the second C-plane message, one or more second beamforming weights for the one or more inactive antennas are absent, and the one or more first beamforming weights are included in a same sequence in which the one or more active antennas are indicated in the first C-plane message.
Aspect 2: The method of aspect 1, wherein the first C-plane message comprises a format indicator to specify that the second C-plane message, which follows the first C-plane message, comprises first beamforming weight information in a reduced format, and the first beamforming weight information in the reduced format exclusively indicates the one or more first beamforming weights for the one or more active antennas.
Aspect 3: The method of aspect 2, further comprising transmitting, to the second network node, a capability indicator to specify that the first network node supports the first beamforming weight information in the reduced format.
Aspect 4: The method of aspect 3, wherein the transmission of the capability indicator is via a management plane (M-plane) message.
Aspect 5: The method of any of aspects 3 through 4, wherein the transmission of the capability indicator is prior to the reception of the first C-plane message.
Aspect 6: The method of any of aspects 2 through 5, wherein the one or more processors are further configured to obtain the one or more second beamforming weights for the one or more inactive antennas based on the first beamforming weight information in the reduced format.
Aspect 7: The method of aspect 6, wherein the one or more processors are further configured to convert the first beamforming weight information in the reduced format to second beamforming weight information in an expanded format based on the obtained one or more second beamforming weights. The second beamforming weight information in the expanded format indicates the one or more first beamforming weights for the one or more active antennas, respectively, and the obtained one or more second beamforming weights for the one or more inactive antennas, respectively.
Aspect 8: The method of aspect 7, wherein for the conversion of the first beamforming weight information to the second beamforming weight information, the one or more processors are further configured to pad the one or more first beamforming weights with one or more zeroes based on a sequence in which the one or more inactive antennas are indicated in the first C-plane message, and the one or more zeroes correspond to the one or more second beamforming weights.
Aspect 9: The method of any of aspects 7 through 8, wherein each of the one or more first beamforming weights in the second beamforming weight information is at a same indexed position at which a corresponding active antenna of the one or more active antennas is indicated in the first C-plane message, and each of the one or more second beamforming weights in the second beamforming weight information is at a same indexed position at which a corresponding inactive antenna of the one or more inactive antennas is indicated in the first C-plane message.
Aspect 10: The method of any of aspects 7 through 9, wherein the one or more processors are further configured to control the plurality of antennas based on the first C-plane message and the second beamforming weight information.
Aspect 11: The method of aspect 10, wherein the one or more processors are further configured to execute, based on the control of the plurality of antennas, the wireless communication via the one or more active antennas.
Aspect 12: The method of any of aspects 1 through 11, wherein the first C-plane message corresponds to a Section Type 4 (ST4) message and the second C-plane message corresponds to a Section Type 1 (ST1) message.
Aspect 13: The method of any of aspects 1 through 12, wherein the response corresponds to a Section Type 8 (ST8) message.
Aspect 14: A method for wireless communication at a first network node, the method comprising transmitting, to a second network node, a first control plane (C-plane) message associated with a plurality of antennas. The first C-plane message indicates one or more active antennas of the plurality of antennas and one or more inactive antennas of the plurality of antennas. The method further comprises generating a second C-plane message that includes one or more first beamforming weights for the one or more active antennas, respectively, wherein in the second C-plane message, and transmitting the second C-plane message to the second network node. In the second C-plane message, one or more second beamforming weights for the one or more inactive antennas are absent, and the one or more first beamforming weights are included in a same sequence in which the one or more active antennas are indicated in the first C-plane message.
Aspect 15: The method of aspect 14, wherein the first C-plane message comprises a format indicator to specify that the second C-plane message, which follows the first C-plane message, comprises beamforming weight information in a reduced format, and the beamforming weight information in the reduced format exclusively indicates the one or more first beamforming weights for the one or more active antennas.
Aspect 16: The method of aspect 15, further comprising receiving, from the second network node, a capability indicator specifying that the second network node supports the beamforming weight information in the reduced format.
Aspect 17: The method of aspect 16, wherein the reception of the capability indicator is via a management plane (M-plane) message.
Aspect 18: The method of any of aspects 14 through 17, further comprising receiving, from the second network node, a response to the first C-plane message; and transmitting, based on the received response, the second C-plane message to the second network node.
Aspect 19: The method of any of aspects 14 through 18, wherein the first C-plane message comprises a bitmap that includes a plurality of bits for the plurality of antennas, respectively. The plurality of bits includes a first set of bits, each with a first value, that indicates the one or more active antennas, and a second set of bits, each with a second value, that indicates the one or more inactive antennas.
Aspect 20: A first network node for wireless communication, comprising one or more memories and one or more processors coupled to the one or more memories, the one or more processors individually or collectively configured to cause the first network node to perform a method of any of aspects 1 through 13.
Aspect 21: A first network node for wireless communications, comprising at least one means for performing a method of any of aspects 1 through 13.
Aspect 22: A non-transitory computer-readable medium storing code for wireless communications in a first network node, the code comprising instructions executable by a processor to perform a method of any of aspects 1 through 13.
Aspect 23: A first network node for wireless communication, comprising one or more memories and one or more processors coupled to the one or more memories, the one or more processors individually or collectively configured to cause the first network node to perform a method of any of aspects 14 through 19.
Aspect 24: A first network node for wireless communications, comprising at least one means for performing a method of any of aspects 14 through 19.
Aspect 25: A non-transitory computer-readable medium storing code for wireless communications at a first network node, the code comprising instructions executable by a processor to perform a method of any of aspects 14 through 19.

It should be noted that the methods described herein describe possible implementations, and that the operations and the steps may be rearranged or otherwise modified and that other implementations are possible. Further, aspects from two or more of the methods may be combined.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A first network node for wireless communication, comprising:
one or more memories; and
one or more processors coupled to the one or more memories, the one or more processors individually or collectively configured to cause the first network node to:
receive, from a second network node, a first control plane (C-plane) message associated with a plurality of antennas, wherein the first C-plane message indicates one or more active antennas of the plurality of antennas and one or more inactive antennas of the plurality of antennas;
transmit, to the second network node, a response to the first C-plane message; and
receive, from the second network node, a second C-plane message based on the transmitted response, wherein
the second C-plane message includes one or more first beamforming weights for the one or more active antennas, respectively, and
in the second C-plane message:
one or more second beamforming weights for the one or more inactive antennas are absent, and
the one or more first beamforming weights are included in a same sequence in which the one or more active antennas are indicated in the first C-plane message.

2. The first network node of claim 1, wherein
the first C-plane message comprises a format indicator to specify that the second C-plane message, which follows the first C-plane message, comprises first beamforming weight information in a reduced format, and
the first beamforming weight information in the reduced format exclusively indicates the one or more first beamforming weights for the one or more active antennas.

3. The first network node of claim 2, wherein the one or more processors are individually or collectively further configured to cause the first network node to transmit, to the second network node, a capability indicator to specify that the first network node supports the first beamforming weight information in the reduced format.

4. The first network node of claim 3, wherein the transmission of the capability indicator is via a management plane (M-plane) message.

5. The first network node of claim 3, wherein the transmission of the capability indicator is prior to the reception of the first C-plane message.

6. The first network node of claim 2, wherein the one or more processors are individually or collectively further configured to cause the first network node to obtain the one or more second beamforming weights for the one or more inactive antennas based on the first beamforming weight information in the reduced format.

7. The first network node of claim 6, wherein the one or more processors are individually or collectively further configured to cause the first network node to:
convert the first beamforming weight information in the reduced format to second beamforming weight information in an expanded format based on the obtained one or more second beamforming weights, wherein the second beamforming weight information in the expanded format indicates:
the one or more first beamforming weights for the one or more active antennas, respectively, and
the obtained one or more second beamforming weights for the one or more inactive antennas, respectively.

8. The first network node of claim 7, wherein
for the conversion of the first beamforming weight information to the second beamforming weight information, the one or more processors are individually or collectively further configured to cause the first network node to pad the one or more first beamforming weights with one or more zeroes based on a sequence in which the one or more inactive antennas are indicated in the first C-plane message, and
the one or more zeroes correspond to the one or more second beamforming weights.

9. The first network node of claim 7, wherein
each of the one or more first beamforming weights in the second beamforming weight information is at a same indexed position at which a corresponding active antenna of the one or more active antennas is indicated in the first C-plane message, and
each of the one or more second beamforming weights in the second beamforming weight information is at a same indexed position at which a corresponding inactive antenna of the one or more inactive antennas is indicated in the first C-plane message.

10. The first network node of claim 7, wherein the one or more processors are individually or collectively further configured to cause the first network node to control the plurality of antennas based on the first C-plane message and the second beamforming weight information.

11. The first network node of claim 10, wherein the one or more processors are individually or collectively further configured to cause the first network node to execute, based on the control of the plurality of antennas, the wireless communication via the one or more active antennas.

12. The first network node of claim 1, wherein the first C-plane message corresponds to a Section Type 4 (ST4) message and the second C-plane message corresponds to a Section Type 1 (ST1) message.

13. The first network node of claim 1, wherein the response corresponds to a Section Type 8 (ST8) message.

14. A first network node for wireless communication, comprising:
one or more memories; and
one or more processors coupled to the one or more memories, the one or more processors individually or collectively configured to cause the first network node to:
transmit, to a second network node, a first control plane (C-plane) message associated with a plurality of antennas, wherein the first C-plane message indicates one or more active antennas of the plurality of antennas and one or more inactive antennas of the plurality of antennas;
generate a second C-plane message that includes one or more first beamforming weights for the one or more active antennas, respectively, wherein in the second C-plane message:
one or more second beamforming weights for the one or more inactive antennas are absent, and
the one or more first beamforming weights are included in a same sequence in which the one or more active antennas are indicated in the first C-plane message; and
transmit the second C-plane message to the second network node.

15. The first network node of claim 14, wherein
the first C-plane message comprises a format indicator to specify that the second C-plane message, which follows the first C-plane message, comprises beamforming weight information in a reduced format, and
the beamforming weight information in the reduced format exclusively indicates the one or more first beamforming weights for the one or more active antennas.

16. The first network node of claim 15, wherein the one or more processors are individually or collectively further configured to cause the first network node to receive, from the second network node, a capability indicator specifying that the second network node supports the beamforming weight information in the reduced format.

17. The first network node of claim 16, wherein the reception of the capability indicator is via a management plane (M-plane) message.

18. The first network node of claim 14, wherein the one or more processors are individually or collectively further configured to cause the first network node to:
receive, from the second network node, a response to the first C-plane message; and
transmit, based on the received response, the second C-plane message to the second network node.

19. The first network node of claim 14, wherein
the first C-plane message comprises a bitmap that includes a plurality of bits for the plurality of antennas, respectively, and
the plurality of bits includes:
a first set of bits, each with a first value, that indicates the one or more active antennas, and
a second set of bits, each with a second value, that indicates the one or more inactive antennas.

20. A wireless communication method, comprising:
in a first network node:
receiving, from a second network node, a first control plane (C-plane) message associated with a plurality of antennas, wherein the first C-plane message indicates one or more active antennas of the plurality of antennas and one or more inactive antennas of the plurality of antennas;
transmitting, to the second network node, a response to the first C-plane message; and
receiving, from the second network node, a second C-plane message based on the transmitted response, wherein
the second C-plane message includes one or more first beamforming weights for the one or more active antennas, respectively, and
in the second C-plane message:
one or more second beamforming weights for the one or more inactive antennas are absent, and
the one or more first beamforming weights are included in a same sequence in which the one or more active antennas are indicated in the first C-plane message.
